(19) United States
(12) Patent Application Publication
(10) Pub. No.: US 2026/0234982 A1
(43) Pub. Date: Aug. 13, 2026

(54) REFRIGERATOR AND DOOR OPENING AND CLOSING DEVICE

(71) Applicants: LG Electronics Inc., Seoul (KR); Pusan National University Industry-University Cooperation Foundation, Busan (KR)

(72) Inventors: Jinho CHANG, Seoul (KR); Heejun LEE, Seoul (KR); Sanghu PARK, Busan (KR); Yoongho JUNG, Busan (KR)

(21) Appl. No.: 19/532,058

(22) Filed: Feb. 6, 2026

(30) Foreign Application Priority Data
Feb. 7, 2025 (KR) 10-2025-0015852

(51) Int. Cl. E05F 15/63; F25D 23/02

(52) U.S. Cl. CPC E05F 15/63; F25D 23/028; E05Y 2201/216; E05Y 2201/712; E05Y 2201/716; E05Y 2201/722; E05Y 2900/31; F25D 2323/024

(57) ABSTRACT

A refrigerator includes a cabinet, a door, and a door opening and closing device. The door opening and closing device includes a driver, a power transmission portion, and an operating portion having a link connected to the door. The power transmission portion includes a clutch gear assembly, and the clutch gear assembly is configured to transmit power to the operating portion or block the power transmission. The clutch gear assembly includes a shaft, an input gear through which the shaft passes and which is connected to the driver, an output gear spaced apart from the input gear, and a connection gear configured to move in an axial direction of the shaft when the driver is operated to connect the input gear with the output gear, and move in the axial direction of the shaft to disconnect between the input gear and the output gear when the driver is stopped.

### CROSS-REFERENCE TO RELATED APPLICATIONS

The present application claims priority under 35 U.S.C. 119 to Korean Patent Application No. 10-2025-0015852, filed in the Republic of Korea on Feb. 7, 2025, which is hereby incorporated by reference in its entirety.

### FIELD

The present disclosure relates to a refrigerator and a door opening and closing device.

### BACKGROUND

In general, a refrigerator is a home appliance for storing foods in an internal storage space, which is shielded by a door, at a low temperature by low temperature air.

The storage space is surrounded by an insulating wall so that an inside of the storage space is maintained at a temperature lower than an outside temperature. Depending on a temperature range of the storage space, the storage space may be called as a refrigerating chamber or a freezing chamber.

To put an object into or take the object out of the storage space, the user opens the door. Typically, the door is rotatably installed on the cabinet, and a gasket is provided between the door and the cabinet. Therefore, when the door is closed, the gasket seals tightly between the door and the cabinet, preventing cold air from leaking from the storage space. A greater a sealing force of this gasket, a greater an effect of preventing cold air from leaking.

To increase a sealing force of the gasket, the gasket may be formed of a rubber, and a magnet may be provided within the gasket. However, as the sealing force of the gasket increases, a greater force is required to open the door.

Accordingly, a refrigerator with automatic door opening functions have recently been introduced. A related prior art document is China Utility Model Registration No. 218324468.

### SUMMARY

One embodiment provides a refrigerator and a door opening and closing device that increases a door opening angle when the door is automatically opened.

Alternatively or additionally, one embodiment provides a refrigerator and a door opening and closing device that can automatically open and close the door.

Alternatively or additionally, one embodiment provides a refrigerator and a door opening and closing device in which the door can be opened automatically as well as manually by a user.

Alternatively or additionally, one embodiment provides a refrigerator and a door opening and closing device that prevents damage to a driver and allows the door to close smoothly when the user manually closes the door in a state in which the driver is stopped after operation.

Alternatively or additionally, one embodiment provides a refrigerator and a door opening and closing device in which damage to a driver for automatic opening is prevented when the door is manually opened.

A refrigerator according to one aspect may include a cabinet having a storage space; a door that opens and closes the storage space; and a door opening and closing device to open and close the door.

The door opening and closing device may include a driver that generates power, a power transmission portion that transmits the power of the driver, and an operating portion that receives the power of the driver and operates to open the door. The operating portion may include a link connected to the door.

The power transmission portion may include a clutch gear assembly. The clutch gear assembly may transmit power to the operating portion or block power transmission.

The clutch gear assembly may include a shaft, an input gear through which the shaft passes and is connected to the driver, an output gear spaced apart from the input gear, and a connection gear that moves in an axial direction of the shaft to connect the input gear to the output gear when the driver is operated, and moves in the axial direction of the shaft to disconnect the input gear and the output gear when the driver is stopped.

When the driver is stopped, the connection gear may be positioned at an initial position.

When the driver is operated, the connection gear may move from the initial position to a power transmission position in the axial direction of the shaft.

At the power transmission position of the connection gear, the output gear can rotate together with the input gear and the connection gear. At the power transmission position of the connection gear, the output gear and the connection gear can rotate in the same direction as the input gear.

The clutch gear assembly may further include an elastic member for returning the connection gear to the initial position when the driver is stopped during an operation of the driver.

The input gear may include a first cam portion, and the connection gear may include a second cam portion in contact with the first cam portion.

Each of the first cam portion and the second cam portion has a height that is variable in an axial direction or a circumferential direction.

When the driver is operated, the connection gear may move toward the output gear in the axial direction of the shaft by a rotation of the input gear.

Each of the first cam portion and the second cam portion may include a contact surface that contacts each other in the axial direction of the shaft.

Each of the first cam portion and the second cam portion may include a first end and a second end. The second end may be positioned closer to the output gear in the axial direction of the shaft than the first end.

The connection gear may include a body through which the shaft passes, and a plurality of first transmission protrusions protruding from the body toward the output gear.

The output gear may include a plurality of second transmission protrusions capable of interacting with the plurality of the first transmission protrusions.

At the initial position of the connection gear, the plurality of first transmission protrusions may be spaced apart from the plurality of second transmission protrusions in the axial direction of the shaft.

When the driver operates and the connection gear moves from the initial position to the power transmission position, at least one of the plurality of first transmission protrusions may be in contact with at least one of the plurality of second transmission protrusions, so that the connection gear and the output gear can rotate together.

The connection gear may include an opening through which the shaft passes, and a plurality of first protrusions protruding from a surface forming the opening and spaced apart from each other in a circumferential direction.

The shaft may include a first portion, a second portion having a diameter greater than a diameter of the first portion, and a second protrusion protruding from the second portion and positioned between two adjacent first protrusions at the initial position of the connection gear.

In a state in which the second protrusion is positioned between two adjacent first protrusions and the second protrusion is in contact with one or more first protrusions, when the input gear rotates, the connection gear may move in an axial direction of the shaft in a state in which a rotation of the connection gear is restricted.

When the second protrusion moves out from between two adjacent first protrusions, the connection gear may become in a rotatable state.

The connection gear may include a cam portion having a protrusion for interacting with the input gear.

The shaft may include a first portion, a second portion positioned outside the first portion, and a bearing rotatably connected to the second portion.

At the initial position of the connection gear, the bearing may be in contact with the protrusion.

The shaft may extend in a first direction, and a rotational center line of the bearing may extend in a second direction crossing the first direction.

When the input gear rotates in a state in which the bearing is in contact with the protrusion, the connection gear may move in the axial direction of the shaft in a state in which a rotation of the connection gear is restricted.

When the bearing and the protrusion are spaced apart from each other, the connection gear may become in a rotatable state.

The clutch gear assembly may further include a bearing member connected to the connection gear and including a ball bearing.

The shaft may include a first slot in which the ball bearing is received at the initial position of the connection gear, and a second slot extending in a direction crossing an extension direction of the first slot and in which the ball bearing is received at a power transmission position of the connection gear.

The first slot may extend in the axial direction of the shaft, and the second slot may extend in a circumferential direction of the shaft.

When the input gear rotates in a state in which the ball bearing is positioned in the first slot, the ball bearing may move along the first slot in a state in which a rotation of the connection gear is restricted.

When the ball bearing is positioned in the second slot, the connection gear may become in a rotatable state.

The operating portion may include a first operating portion that operates by receiving power from the driver, and a second operating portion that operates by receiving power from the driver from the output gear assembly and is positioned at a position spaced apart from a rotation center of the door. The second operating portion may include the link.

When the driver operates to automatically open the door, the first operating portion may start to operate, and the second operating portion may start to operate after the first operating portion starts to operate.

A door opening and closing device according to another aspect may include a driver that generates power, a power transmission portion that transmits the power of the driver, and an operating portion that receives the power of the driver and operates to open the door. The operating portion may include a first operating portion that operates by receiving power from the driver, and a second operating portion that operates by receiving power from the driver and has a link.

The power transmission portion may include a clutch gear assembly. The clutch gear assembly may transmit power to the second operating portion or block power transmission.

The clutch gear assembly may include an input gear connected to the driver, an output gear spaced apart from the input gear, and a connection gear that receives rotational force of the input gear when the driver is operated, moves toward the output gear, connects the input gear to the output gear, and disconnects the input gear and the output gear when the driver is stopped.

The clutch gear assembly may further include a shaft passing through the input gear, the connection gear, and the output gear.

The connection gear may move along an axial direction of the shaft when the input gear rotates.

When the driver is stopped, the connection gear is positioned at an initial position, and when the driver operates, the connection gear may move from the initial position to a power transmission position in an axial direction of the shaft.

During an operation of the driver, the connection gear may move along the axial direction of the shaft in a state in which a rotation of the connection gear is restricted.

When the connection gear moves to the power transmission position, the connection gear may become in a rotatable state.

The clutch gear assembly may further include an elastic member for causing the connection gear to move from the power transmission position to the initial position when the driver is stopped.

According to one embodiment, there is an advantage in that an opening angle of the door is increased when the door is automatically opened.

According to an embodiment, there is an advantage in that the door can be not only automatically opened but also automatically closed.

According to an embodiment, there is an advantage in that the door can be not only automatically opened but also manually opened by a user.

According to an embodiment, when the driver stops after operating, a connection between the driver and the transmission unit is released. This provides advantages of not only preventing damage to the driver while a user manually closes the door but also allowing the door to be closed smoothly.

According to an embodiment, there is an advantage in that damage to the driver for automatic opening is prevented when the door is manually opened, and operating noise is reduced.

### BRIEF DESCRIPTION OF THE DRAWINGS

FIG. 1 is a perspective view showing a portion of a refrigerator according to a first embodiment.

FIG. 2 is a plan view of a refrigerator according to a first embodiment.

FIG. 3 is an enlarged view showing a door opening and closing device installed at a refrigerator according to a first embodiment.

FIG. 4 is a drawing showing a portion of a power transmission portion of a door opening and closing device according to a first embodiment.

FIG. 5 is a cross-sectional view of a fifth gear for transmitting power to a first operating portion.

FIG. 6A is a perspective view of a transmission gear, and FIG. 6B is a side view of a transmission gear.

FIG. 7 is a perspective view showing a clutch gear assembly according to a first embodiment.

FIG. 8 is an exploded perspective view of a clutch gear assembly according to a first embodiment.

FIG. 9 is a perspective view of an input gear according to a first embodiment.

FIGS. 10A and 10B are perspective views of a connection gear according to a first embodiment.

FIG. 11 is a perspective view of an output gear according to a first embodiment.

FIG. 12 is a drawing showing a connection gear received in an input gear according to a first embodiment.

FIGS. 13A and 13B are drawings showing a clutch gear assembly in a stopped state of a driver according to a first embodiment.

FIGS. 14A and 14B are drawings showing a clutch gear assembly when a driver operates according to a first embodiment.

FIGS. 15 to 22 are drawings showing a process of automatically opening a door.

FIGS. 23 to 26 are drawings showing a process of automatically closing a door.

FIGS. 27A to 27D are views showing a process in which a moving portion of a fifth gear moves into a slot of a transmission gear while a door is automatically closed.

FIG. 28 is a control block diagram of a refrigerator according to a first embodiment.

FIGS. 29 and 30 are drawings showing a process of manually opening a door.

FIG. 31 is a perspective view showing a clutch gear assembly according to a second embodiment.

FIG. 32 is an exploded perspective view of a clutch gear assembly according to a second embodiment.

FIGS. 33A and 33B are perspective views of a connection gear according to a second embodiment.

FIG. 34 is a perspective view of an output gear according to a second embodiment.

FIG. 35 is a cross-sectional view taken along line 35-35 of FIG. 32.

FIGS. 36A and 36B are views showing a clutch gear assembly in a stopped state of a driver according to a second embodiment.

FIGS. 37A and 37B are drawings showing a clutch gear assembly when a driver operates according to a second embodiment.

FIG. 38 is a perspective view showing a clutch gear assembly according to a third embodiment.

FIG. 39 is an exploded perspective view of a clutch gear assembly according to a third embodiment.

FIGS. 40A and 40B are perspective views of a connection gear according to a third embodiment.

FIG. 41 is a perspective view of a bearing member according to a third embodiment.

FIG. 42 is a perspective view of a shaft according to a third embodiment.

FIGS. 43A and 43B are drawings showing a clutch gear assembly in a stopped state of a driver according to a third embodiment.

FIGS. 44A and 44B are drawings showing a clutch gear assembly when a driver operates according to a third embodiment.

FIG. 45 is a cross-sectional view taken along line 45-45 of FIG. 44B.

### DETAILED DESCRIPTION

Hereinafter, some embodiments of the present disclosure will be described in detail with reference to the accompanying drawings. It should be noted that when components in the drawings are designated by reference numerals, the same components have the same reference numerals as far as possible even though the components are illustrated in different drawings. Further, in description of embodiments of the present disclosure, when it is determined that detailed descriptions of well-known configurations or functions disturb understanding of the embodiments of the present disclosure, the detailed descriptions will be omitted.

Also, in the description of the embodiments of the present disclosure, the terms such as first, second, A, B, (a) and (b) may be used. Each of the terms is merely used to distinguish the corresponding component from other components, and does not delimit an essence, an order or a sequence of the corresponding component. It should be understood that when one component is “connected”, “coupled” or “joined” to another component, the former may be directly connected, coupled or joined to the latter or may be “connected”, coupled” or “joined” to the latter with a third component interposed therebetween.

In this specification, at least one of component A and component B may be interpreted as including component A, component B, or components A+B.

Furthermore, at least one of component A or component B may be interpreted as including component A, component B, or components A+B.

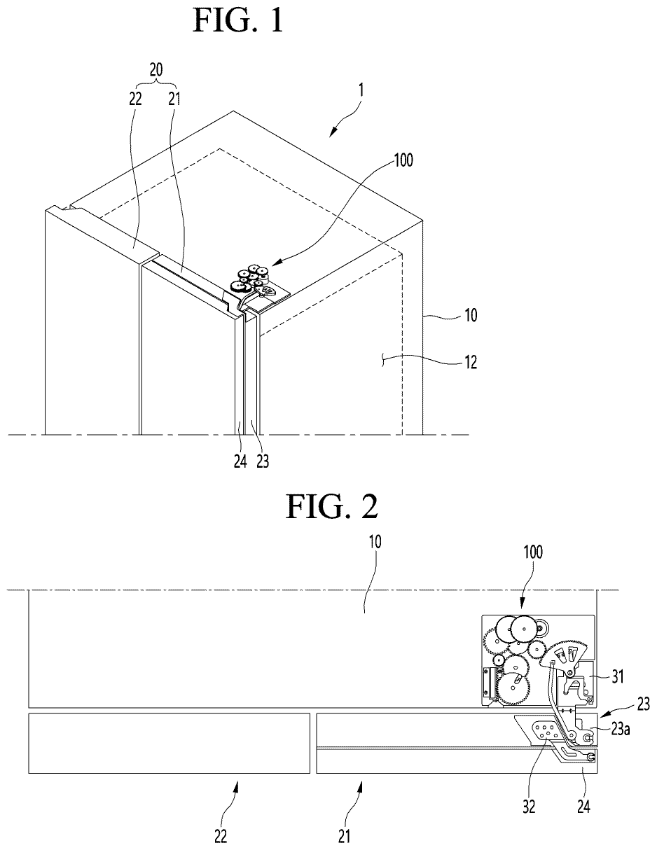

FIG. 1 is a perspective view showing a portion of a refrigerator according to a first embodiment. FIG. 2 is a plan view of a refrigerator according to a first embodiment.

Referring to FIGS. 1 and 2, a refrigerator 1 according to the present embodiment may include a cabinet 10 to form a storage space 12 and a door 20 that opens and closes the storage space 12.

The storage space 12 may include, for example, a refrigerating chamber. Alternatively, the storage space 12 may include, for example, a freezing chamber. Alternatively, although not shown, the storage space 12 may further include an additional storage space.

The door 20 may be a refrigerating chamber door or a freezing chamber door. The door 20 may include a first door 21 that opens and closes a portion of the storage space 12. The door 20 may further include a second door 22 that opens and closes another portion of the storage space 12. Alternatively, a single door 20 may open and close a single storage space 12, or may open and close multiple storage spaces 12 simultaneously.

The door 20 may be configured as a single door, or may include a main door 23 and a sub-door 24.

As an example, FIG. 2 illustrates that the first door 21 among the doors 20 is composed of a main door 23 (or inner door) and a sub-door 24 (or outer door), but is not limited thereto, and it is also possible for the first door 21 to be composed of a single door.

The main door 23 may open and close the storage space 12, and the sub-door 24 may be rotatable with respect to the main door 23. The sub-door 24 may be rotatably connected to the main door 23 or rotatably connected to the cabinet 10.

A refrigerator of the present embodiment may further include a door opening and closing device 100 for opening the door 20. When the door 20 includes a plurality of doors 21 and 22, the door opening and closing device 100 may open some or all of the plurality of doors 21 and 22.

FIG. 2 illustrates, as an example, the door opening and closing device 100 opening the first door 21 among the doors 20.

In the present embodiment, the door 20 may be automatically opened by the door opening and closing device 100. Additionally, the door 20 may be manually opened by a user.

The door opening and closing device 100 may be installed at an upper surface of the cabinet 10, for example, but may also be installed at a lower surface. A portion of the door opening and closing device 100 may be connected to an upper (or lower) side of the door 20.

When the door 20 includes a main door 23 and a sub door 24, a portion of the door opening and closing device 100 may be connected to an upper side of the main door 23. That is, when the door opening and closing device 100 is operated, the main door 23 may be automatically opened.

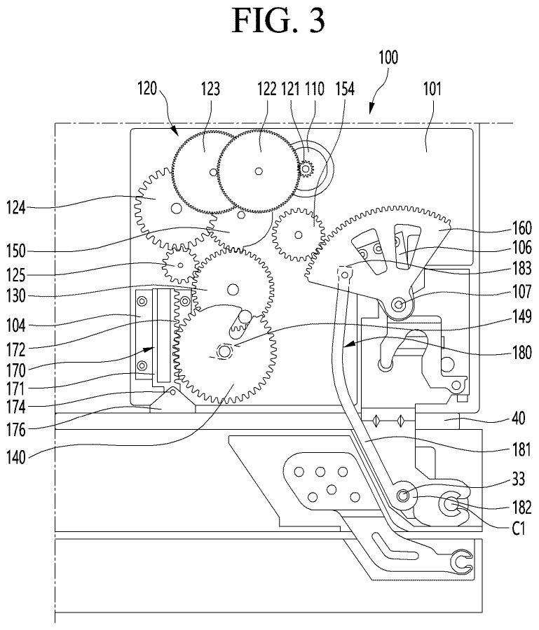

A gasket 40 of FIG. 3 may be provided between the door 20 and the cabinet 10 to limit leakage of cold air from the storage space 12. For example, a gasket 40 is coupled to the door 20. A magnet may be provided inside the gasket 40. The gasket 40 may be maintained in contact with the cabinet 10 by the magnet.

Hereinafter, the door opening and closing device 100 of the present embodiment will be described in detail.

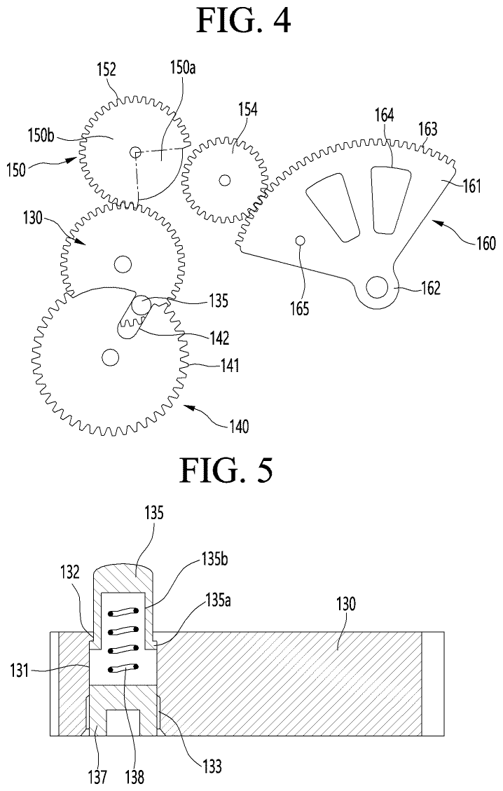

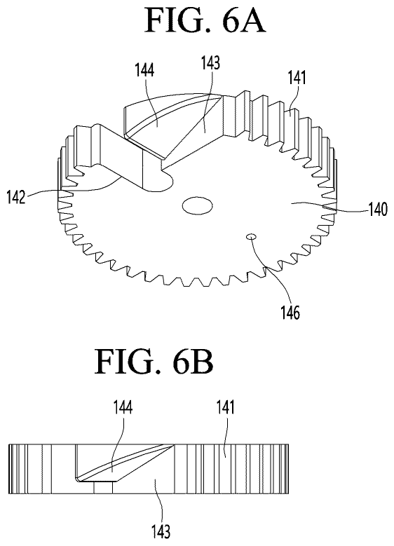

FIG. 3 is an enlarged view showing a door opening and closing device installed at a refrigerator according to a first embodiment. FIG. 4 is a drawing showing a portion of a power transmission portion of a door opening and closing device according to a first embodiment. FIG. 5 is a cross-sectional view of a fifth gear for transmitting power to a first operating portion. FIG. 6A is a perspective view of a transmission gear, and FIG. 6B is a side view of a transmission gear.

Referring to FIGS. 2 to 6B, the main door 23 may be rotatably connected to the cabinet 10 by a first hinge bracket 31. An upper surface of the main door 23 may include a recess 23a that is recessed downward. The first hinge bracket 31 may be connected to the recess 23a.

The sub-door 24 may be rotatably connected to the main door 23 by a second hinge bracket 32.

A door opening and closing device 100 of the present embodiment may include a driver 110. The driver 110 may include, for example, a motor capable of rotating in both directions. When the motor rotates in a forward direction, the door 20 may be automatically opened. After the door is automatically opened, when the motor rotates in a reverse direction, the door 20 may be automatically closed.

The door opening and closing device 100 may further include a power transmission portion 120 for transmitting power of the driver 110.

The door opening and closing device 100 may further include a first operating portion 170 (or first door opening portion) that operates by receiving power from the power transmission portion 120. The door opening and closing device 100 may further include a second operating portion 180 (or second door opening portion) that operates by receiving power from the power transmission portion 120.

In the auto opening process of the door 20, the first operating portion 170 and the second operating portion 180 may operate sequentially. The second operating portion 180 functions as a door closing portion to close the door during an auto closing process of the door.

The door opening and closing device 100 may further include a first transmission unit that transmits power to the first operating portion 170. The door opening and closing device 100 may further include a second transmission unit that transmits power to the second operating portion 180.

The power transmission portion 120 may include a plurality of gears. The door opening and closing device 100 may include a frame 101. The plurality of gears may be rotatably supported by the frame 101. The frame 101 may cover at least a portion of components constituting the door opening and closing device 100.

For example, the plurality of gears may include a motor gear 121 connected to a shaft of the driver 110.

The plurality of gears may further include first to fifth gears 122, 123, 124, 125, and 130 that are connected to each other. However, it should be noted that there is no limitation on a number of the plurality of gears in the present embodiment. In addition, it should be noted that there is no limitation on a shape of the plurality of gears.

The first gear 122 and the second gear 123 may be reduction gears. The third to fifth gears 124, 125, and 130 may be idle gears.

The last gear among the plurality of gears may be connected to the first transmission unit. For example, the fifth gear 130 may be connected to the first transmission unit.

The first transmission unit may transmit power to the first operating portion 170 during a portion of the auto opening process of the door 20. For example, the first transmission unit may transmit power to the first operating portion 170 in an initial period of the auto opening process. The first transmission unit can block power transmission to the first operating portion 170 in another period of the auto opening process. That is, the first transmission unit can block power transmission during operation of the first operating portion 170.

The first transmission unit may include a transmission gear 140. The transmission gear 140 may be connected to the fifth gear 130.

The fifth gear 130 may include a moving portion 135. The moving portion 135 may be provided to be movable at a position spaced apart from a rotational center of the fifth gear 130. The moving portion 135 may move in a direction parallel to a rotational center line of the fifth gear 130.

The fifth gear 130 may include a first portion 131 in which the moving portion 135 is received. The fifth gear 130 may include a second portion 132 as an opening through which the moving portion 135 passes. A diameter of the first portion 131 may be greater than a diameter of the second portion 132.

The fifth gear 130 may further include a third portion 133 as an opening for insertion of the moving portion 135. The first portion 131 may be positioned between the second portion 132 and the third portion 133. A diameter of the third portion 133 may be equal to or greater than a diameter of the first portion 131.

The fifth gear 130 may further include a cover portion 137 for covering the third portion 133. A diameter of the cover portion 137 may be equal to or less than that of the third portion 133. A portion of the cover portion 137 may be inserted into the first portion 131. The cover portion 137 may restrict the moving portion 135 from being separated from the fifth gear 130 toward the third portion 133.

A portion protruding outwardly from the fifth gear 130 in the moving portion 135 may include a round surface. The round surface may be in contact with the transmission gear 140.

The moving portion 135 may be formed in a cylindrical shape, for example. Based on the drawing, an upper surface of the moving portion 135 may include a round surface.

The moving portion 135 may further include an extension 135a extending outward. A portion of the moving portion 135 may pass through the second portion 132 and protrude outwardly of the fifth gear 130. The extension 135a may be caught by a step formed by a difference in diameter between the first portion 131 and the second portion 132. The extension 135a can be moved within the first portion 131.

An upward movement of the moving portion 135 can be limited by the extension 135a. A downward movement of the extension 135a can be limited by the cover portion 137 or an elastic member 138 described below.

The fifth gear 130 may further include an elastic member 138 that provides elastic force to the moving portion 135. The elastic member 138 may elastically support the moving portion 135. The elastic member 138 may be, for example, a coil spring.

A groove 135b may be formed in the moving portion 135 to receive a portion of the elastic member 138. Another side of the elastic member 138 may be supported by the cover portion 137.

After the moving portion 135 is moved downward by an external force, when the external force is removed, the moving portion 135 may be moved upward by the elastic force of the elastic member 138.

The transmission gear 140 may be provided with a gear tooth 141 on a portion of the circumferential surface. Another portion of the transmission gear 140, where the gear tooth 141 is not provided, may be provided with a slot 142 in which the moving portion 135 is received. The slot 142 may pass through the transmission gear 140 in a direction parallel to a rotational center line of the transmission gear 140. Alternatively, the slot 142 may be recessed toward a rotational center of the transmission gear 140 on the circumferential surface.

The moving portion 135 may be selectively received in the slot 142. When the moving portion 135 is received in the slot 142, the rotational power of the fifth gear 130 may be transmitted to the transmission gear 140. On the other hand, when the moving portion 135 is removed from the slot 142, a rotational power of the fifth gear 130 is not transmitted to the transmission gear 140.

In this embodiment, a state in which the moving portion 135 is received in the slot 142 may be referred to as a connected state of the fifth gear 130 and the transmission gear 140. In the connected state of the fifth gear 130 and the transmission gear 140, the transmission gear 140 may rotate together when the fifth gear 130 rotates.

A state in which the moving portion 135 is removed from the slot 142 may be referred to as a disconnected state of the fifth gear 130 and the transmission gear 140. In the disconnected state of the fifth gear 130 and the transmission gear 140, even if the fifth gear 130 rotates, the transmission gear 140 may not rotate.

The transmission gear 140 may further include a recess 143 provided at one side of the slot 142. The recess 143 may be in communication with the slot 142.

The recess 143 may provide a path or space through which the moving portion 135, located at an outside of the slot 142, may be inserted into the slot 142. One surface forming the recess 143 in the transmission gear 140 may include an inclined surface 144. The inclined surface 144 may be inclined such that a recessed depth of the recessed portion 143 upward from a bottom surface decreases toward the slot 142. The moving portion 135 may be in contact with the inclined surface 144.

The transmission gear 140 may be connected to an elastic body 149. In order to open the door 20, the transmission gear 140 may be rotated in the other direction. While the transmission gear 140 rotates in the other direction, when the moving unit 135 is removed from the slot 142, the elastic body 149 may provide an elastic force so that the transmission gear 140 returns to an initial position in one direction.

The elastic body 149 may be, for example, a torsion spring, but it should be noted that there is no limitation on the type of spring. The transmission gear 140 may be provided with a coupling portion 146 to which the elastic body 149 is coupled.

As another example, it is also possible for the elastic body 149 to provide elastic force to the first operating portion 170. In this case, when the moving portion 135 is removed from the slot 142, the elastic body 149 can provide elastic force so that the first operating portion 170 returns to an initial position. In the process of returning the first operating portion 170 to the initial position, the transmission gear 140 can return to the initial position in one direction.

In the present embodiment, the first transmission unit acts as a clutch that transmits power to or blocks power transmission to the first operating portion 170 in the auto opening process of the door 20, and thus may be called a first clutch unit.

The first operating portion 170 may be engaged with the transmission gear 140. The first operating portion 170 may be composed of a single member or a plurality of members.

For example, the first operating portion 170 may include a first member 171 that engages with the transmission gear 140, and a second member 176 that is rotatably connected to the first member 171.

The first member 171 may include a rack gear 172. When the transmission gear 140 rotates, the first member 171 may move linearly. The door opening and closing device 100 may further include a guide portion 104 that guides the movement of the first member 171. The guide portion 104 may be formed integrally with the frame 101 or may be coupled to the frame 101.

The second member 176 may be rotatably connected to the first member 171 by a shaft 174. The second member 176 may be in contact with the door 20 during an auto opening process of the door. A portion of the second portion 176 may include a portion whose width or thickness increases as a distance from the shaft 174 increases.

The second transmission unit may include a first transmission portion 150. The first transmission portion 150 may be connected to the fifth gear 130.

The first transmission portion 150 may include a first portion 150a and a second portion 150b, which are distinguished by the presence or absence of gear teeth on the circumferential surface.

There are no gear teeth on the circumferential surface of the first portion 150a. There are gear teeth 152 on the circumferential surface of the second portion 150b. That is, the first transmission portion 150 may be a partial gear. The second portion 150b may be engaged with the fifth gear 130.

The second transmission unit may further include a second transmission portion 154. The second transmission portion 154 may be connected to the first transmission portion 150 during an auto opening process of the door 20. On the other hand, the second transmission portion 154 may be spaced apart from the first transmission portion 150 during a manual opening process of the door 20.

When the door 20 is closed, the first portion 150a may be positioned to face the second transmission portion 154 or to correspond to the second transmission portion 154.

When the driver 110 operates, the first transmission portion 150 may be rotated. When a predetermined time has elapsed since the driver 110 started operating or the first transmission portion 150 is rotated by a predetermined angle, the second portion 150b is connected to the second transmission portion 154 so that the second transmission portion 154 can be rotated.

A state in which the second portion 150b is connected to the second transmission portion 154 can be referred to as a connected state of the first transmission portion 150 and the second transmission portion 154. A state in which the second portion 150b is not connected to the second transmission portion 154 can be referred to as a disconnected state of the first transmission portion 150 and the second transmission portion 154. A position of the first transmission portion 150 in the disconnected state may be referred to as a disconnected position. In the auto opening process of the door 20, the first transmission portion 150 may move to a connected position so that the first transmission portion 150 and the second transmission portion 154 may be connected.

The second transmission unit may further include a third transmission portion 160. The third transmission portion 160 may be connected to the second transmission portion 154. The third transmission portion 160 may be connected to the second operating portion 180. The third transmission portion 160 may transmit the rotational force of the second transmission portion 154 to the second operating portion 180.

The third transmission portion 160 may include, for example, a body 161 formed in a fan shape. A gear tooth 163 may be formed on one surface of the body 161.

Another surface of the body 161 may be provided with a connection portion 162 to which a shaft 107 providing a center of rotation is connected. The shaft 107 may be provided at the first hinge bracket 31, or may be provided on a separate member 106 from the first hinge bracket 31. At least a portion of the third transmission portion 160 may overlap the first hinge bracket 31 in a vertical direction.

The third transmission portion 160 may further include a connection portion 165 to which the second operating portion 180 is connected. The second operating portion 180 may be rotatably connected to the third transmission portion 160 at a position spaced apart from a rotational center of the third transmission portion 160.

The third transmission portion 160 may include one or more holes 164. The one or more holes 164 may improve a strength of the third transmission portion 160. A weight of the third transmission portion 160 may be reduced by the one or more holes 164.

In a case where a plurality of holes 164 are formed in the third transmission portion 160, the plurality of holes can also be used to detect a position of the third transmission portion 160 by a position detection sensor.

The second operating portion 180 may include a body 181 (or link). The body 181 may extend from the cabinet 10 toward the door 20.

The second operating portion 180 may include a first coupling portion 182 provided on one side of the body 181. The first coupling portion 182 may be rotatably connected to a shaft 33 provided on the door 20 (for example, the main door). Alternatively, it is also possible for the first coupling portion 182 to have a shaft. The first coupling portion 182 may be positioned in the recess 23a of the main door 22. The shaft 33 may be provided at the first hinge bracket 31, or may be provided at a separate member spaced apart from or coupled to the first hinge bracket 31.

The body 181 may be formed in a straight shape or in a shape that is bent one or more times. When the door 20 is closed, the first coupling portion 182 may be positioned near a rotation center C1 of the door 20 (or a rotation center of the main door). For example, when the door 20 is closed, the first coupling portion 182 may be positioned closer to the cabinet 10 or the gasket 40 than the rotation center C1 of the door 20.

The second operating portion 180 may include a second coupling portion 183 provided on the other side of the body 181. The second coupling portion 183 may be connected to the third transmission portion 160.

By a shape of the first transmission portion 150, the second transmission unit can transmit the power of the driver 110 to the second operating portion 180 during the automatic opening and closing process of the door 20, and acts as a clutch to block the movement power of the second operating portion 180 from being transmitted to the driver 110 during the manual opening and closing process of the door 20. Therefore, the second transmission unit can be called a second clutch unit.

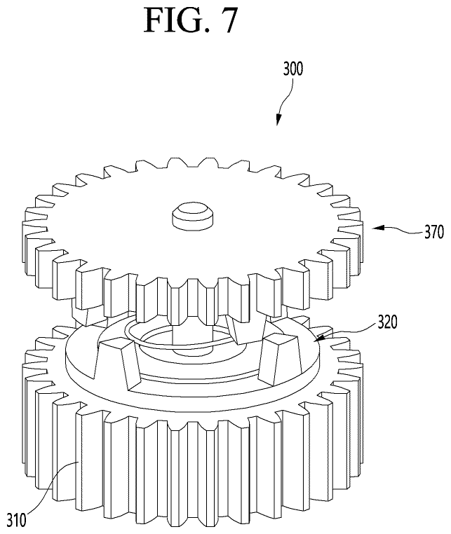

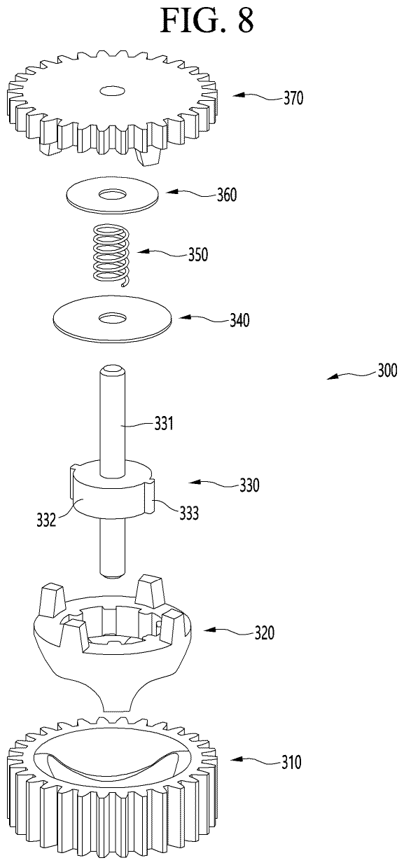

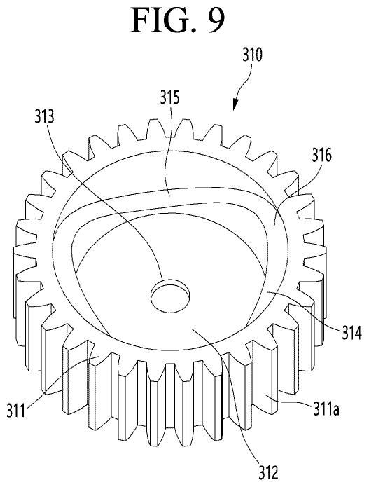

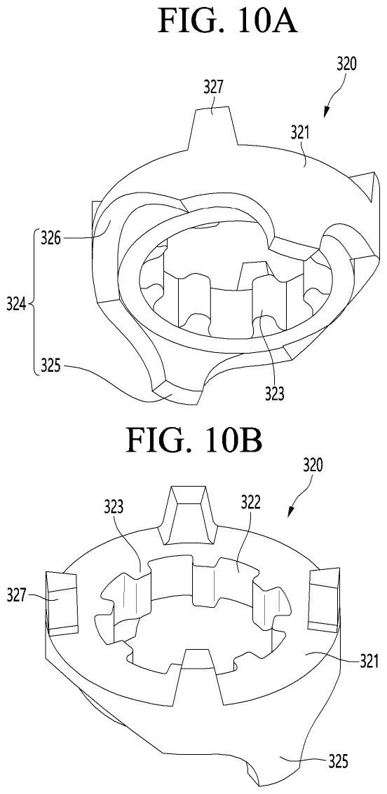

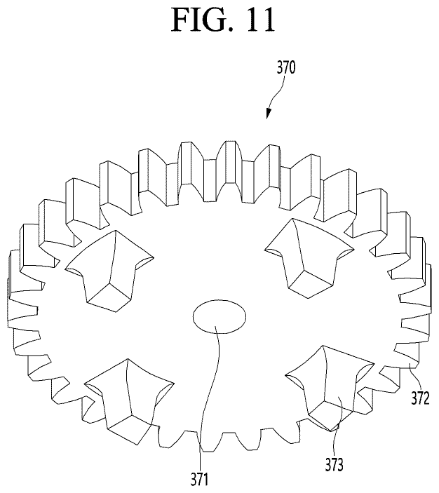

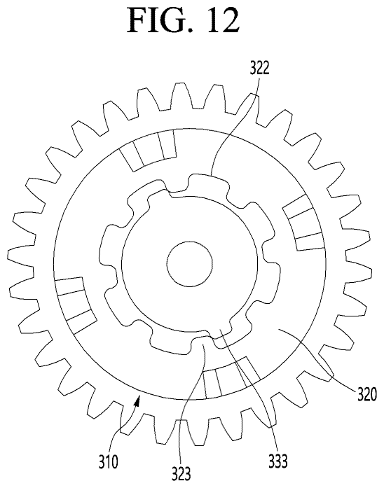

FIG. 7 is a perspective view showing a clutch gear assembly according to a first embodiment. FIG. 8 is an exploded perspective view of a clutch gear assembly according to a first embodiment. FIG. 9 is a perspective view of an input gear according to a first embodiment. FIGS. 10A and 10B are perspective views of a connection gear according to a first embodiment. FIG. 11 is a perspective view of an output gear according to a first embodiment. FIG. 12 is a drawing showing a connection gear received in an input gear according to a first embodiment.

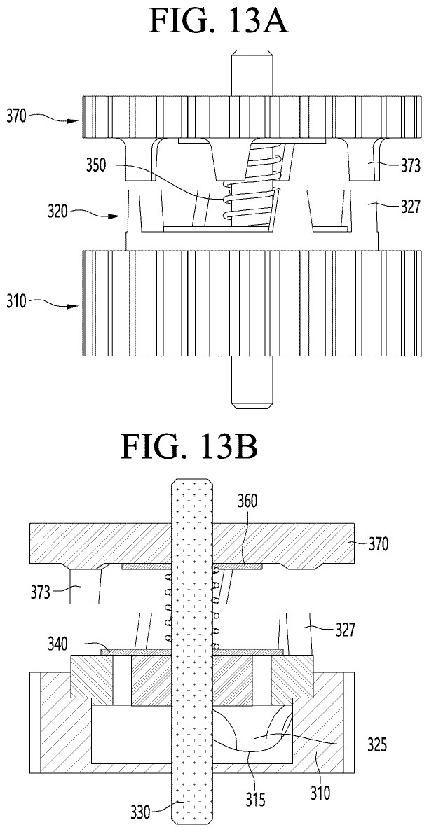

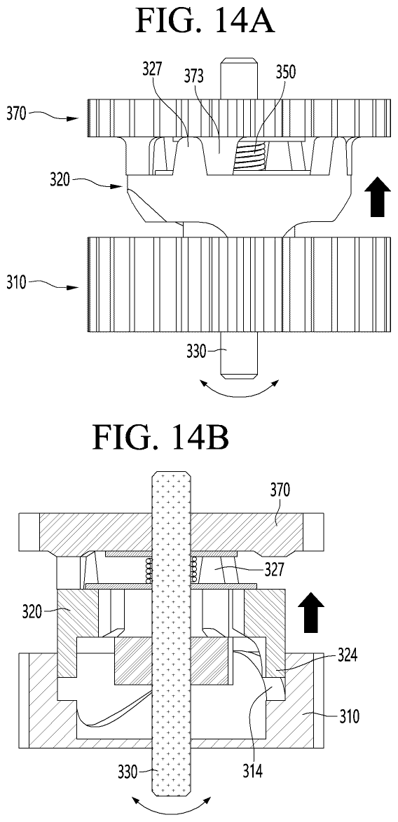

FIGS. 13A and 13B are drawings showing a clutch gear assembly in a stopped state of a driver according to a first embodiment. FIGS. 14A and 14B are drawings showing a clutch gear assembly when a driver operates according to a first embodiment.

Referring to FIGS. 7 to 14B, one of a plurality of gears constituting the power transmission portion 120 may include a clutch gear assembly 300.

The clutch gear assembly 300 may block power transmission between the driver 110 and the second transmission unit when the driver 110 is stopped.

For example, after an automatic opening of the door 20 is completed, the driver 110 may stop before an automatic closing operation of the door 20 begins. Alternatively, the driver 110 may stop unintentionally during the auto opening process of the door 20.

When the automatic opening of the door 20 is completed, the first transmission portion 150 and the second transmission portion 154 are connected. If the clutch gear assembly is not present, the first transmission unit 150 is connected to the driver 110 by the power transmission unit 120. Accordingly, when a user manually closes the door 20, a closing force of the door 20 may be transmitted to the driver 110. In this case, there is a possibility that the driver 110 may be damaged, or the door 20 may not be closed smoothly or softly due to a resistance force of gears. In addition, in a case where the driver 110 unintentionally stops during operation, even when the first transmission unit 150 and the second transmission unit 154 are in a connected state, a closing force of the door 20 may be transmitted to the driver 110 when a user manually closes the door 20.

On the other hand, in a case where the power transmission portion 120 includes the clutch gear assembly 300, the connection between the driver 110 and the first transmission portion 150 is released even if the driver 110 stops after operating or during operation. Accordingly, even when a user manually closes the door 20, a closing force of the door 20 is not transmitted to the driver 110, and the door 20 can be closed manually and smoothly.

Hereinafter, the clutch gear assembly 300 will be described in detail.

Any one of the first to fifth gears 122, 123, 124, 125, and 130 constituting the power transmission portion 120 may include the clutch gear assembly 300.

If the fifth gear 130 includes the clutch gear assembly 300, an output gear 370 of the clutch gear assembly 300, which will be described later, can be formed in a form that includes a structure such as the moving portion 135 described in FIG. 5.

The clutch gear assembly 300 may include an input gear 310. The input gear 310 may be rotated when the driver 110 is operated. The input gear 310 may remain connected to the driver 110 even when the driver 110 is stopped.

The clutch gear assembly 300 may include a shaft 330 that rotatably supports the input gear 310. The shaft 330 may be coupled to pass through the input gear 310. The shaft 330 may be a fixed shaft. The shaft 330 may be fixed to the frame 101 of the door opening and closing device 100.

The clutch gear assembly 300 may further include an output gear 370 that receives a rotational force of the input gear 310. The output gear 370 may be spaced apart from the input gear 310 in an axial direction of the shaft 330.

The clutch gear assembly 300 may further include a connection gear 320. The connection gear 320 may transmit the rotational power of the input gear 310 to the output gear 370 when the driver 110 is operated.

In a stopped state of the driver 110, the connection gear 320 disconnects the input gear 310 and the output gear 370. On the other hand, in an operating state of the driver 110, the connection gear 320 connects the input gear 310 and the output gear 370.

The clutch gear assembly 300 may further include an elastic member 350 for providing elastic force to the connection gear 320. The elastic member 350 operates to release the connection between the connection gear 320 and the output gear 370 when the driver 110 is stopped.

Hereinafter, each component of the clutch gear assembly 300 will be described in more detail.

The input gear 310 may include a gear body 311 having a plurality of gear teeth 311a formed on an outer circumferential surface thereof.

The gear body 311 may include a receiving portion 312 forming a space for receiving a portion of the connection gear 320. For example, the receiving portion 312 may be formed as an upper surface of the input gear 310 is recessed downward.

A hole 313 through which the shaft 330 passes may be formed at a bottom of the receiving portion 312.

The input gear 310 may further include a first cam portion 314.

The first cam portion 314 may be formed on an inner circumferential surface of the receiving portion 312. For example, the first cam portion 314 may protrude from the inner circumferential surface of the receiving portion 312 toward the hole 313. A height of one surface of the first cam portion 314 may vary in an axial direction or a circumferential direction. The one surface of the first cam portion 314 is a surface facing the output gear 370 and may be, for example, an upper surface.

One surface of the first cam portion 314 may be a first contact surface in contact with the connection gear 320.

The first cam portion 314 may include two or more lower end portions 315 (or first ends) and two or more upper end portions 316 (or second ends). The lower end portions 315 and the upper end portions 316 may be alternately arranged. The second ends may be located closer to the output gear 370 in an axial direction of the shaft 330 than the first ends. For example, the first ends may be ends located farthest from the output gear 370. The second ends may be ends located closest to the output gear 370.

In the first cam portion 314, a surface connecting the lower end portion 315 and the upper end portion 316 may be an inclined surface extending in a straight line or may be a rounded surface.

The connection gear 320 may include a body 321 having an opening 322 formed in a center portion thereof.

A plurality of first protrusions 323 may be provided on an inner circumferential surface of the body 321 (a surface forming the opening 322). The plurality of first protrusions 323 may be arranged to be spaced apart from each other in a circumferential direction. Each first protrusion 323 may protrude toward a center of the opening 322.

The body 321 may include a second cam portion 324 that interacts with the first cam portion 314.

The second cam portion 324 may include two or more lower end portions 325 (or first ends) and two or more upper end portions 326 (or second ends). The lower end portions 325 and the upper end portions 326 may be alternately arranged. The second ends may be located closer to the output gear 370 in an axial direction of the shaft 330 than the first ends. The first ends may be ends located farthest from the output gear 370. The second ends may be ends located closest to the output gear 370. The second cam portion 324 may include a second contact surface in contact with the first contact surface of the first cam portion 314. The first contact surface and the second contact surface may be in contact with each other in a longitudinal direction or the axial direction of the shaft 330.

For example, the lower end portion 325 may be formed by a protrusion protruding downward from the body 321. The upper end portion 326 may be formed by a recess in which one surface of the body 321 is recessed upward.

In the second cam portion 324, a surface connecting the lower end portion 325 and the upper end portion 326 may be an inclined surface extending in a straight line or may be a rounded surface.

In a state in which the connection gear 320 is received in the receiving portion 312, the second cam portion 324 may be in contact with the first cam portion 314.

The shaft 330 may include a first portion 331 and a second portion 332 disposed outside the first portion 331. The second portion 332 may protrude from an outer circumferential surface of the first portion 331.

A diameter of the second portion 332 may be greater than a diameter of the first portion 331. The first portion 331 may pass through the hole 313 of the input gear 310.

The second portion 332 may further include a second protrusion 333 protruding in a radial direction. For example, a plurality of second protrusions 333 may be arranged to be spaced apart from each other in a circumferential direction of the second portion 332.

In a stopped state of the driver 110, the lower end portion 325 of the second cam portion 324 may be in contact with the lower end portion 315 of the first cam portion 314, or the upper end portion 326 of the second cam portion 324 may be in contact with the upper end portion 316 of the first cam portion 314.

A position of the connection gear 320 in the stopped state of the driver 110 may be referred to as an initial position or a first position.

In the initial position of the connection gear 320, a height of the connection gear 320 may be the lowest.

In the initial position of the connection gear 320, the second portion 332 of the shaft 330 may be located in the opening 322 of the connection gear 320. A diameter of the second portion 332 may be less than a diameter of the opening 322.

In a state in which the second portion 332 is located in the opening 322 of the connection gear 320, the second protrusion 333 of the second portion 332 may be located between two adjacent first protrusions 323 within the opening 322.

A number of the plurality of second protrusions 333 may be equal to or less than a number of the plurality of first protrusions 323.

A gap between two adjacent first protrusions 323 may be greater than a width of the second protrusion 333.

The second protrusion 333 may restrict rotation of the connection gear 320 until the second portion 332 is located outside the opening 322 of the connection gear 320 or until the second protrusion 333 moves out from between the two adjacent first protrusions 323.

The connection gear 320 may include a plurality of first transmission protrusions 327 protruding from the body 321 toward the output gear 370. The plurality of first transmission protrusions 327 may be arranged to be spaced apart from each other in a circumferential direction.

The clutch gear assembly 300 may further include a first washer 340. The first washer 340 may be seated on the body 321. For example, the first washer 340 is seated on an upper surface of the body 321 and may cover the opening 322.

A diameter of the first washer 340 may be greater than a diameter of the opening 322 of the connection gear 320. The first transmission protrusion 327 may be located outside the first washer 340.

The clutch gear assembly 300 may further include a second washer 360. The second washer 360 may be in contact with a lower surface of the output gear 370.

The first portion 331 of the shaft 330 may pass through the connection gear 320, the first washer 340, the second washer 360, and the output gear 370.

One end of the elastic member 350 may be supported by the first washer 340, and another end thereof may be supported by the second washer 360. Of course, the second washer 360 may be omitted, and the elastic member 350 may be supported by the output gear 370.

The elastic member 350 may be, for example, a coil spring. The elastic member 350 may be arranged to surround the first portion 331 of the shaft 330.

The output gear 370 may include a hole 371 through which the first portion 331 of the shaft 330 passes.

The output gear 370 may include a plurality of gear teeth 372. The output gear 370 may include a plurality of second transmission protrusions 373 capable of interacting with the first transmission protrusions 327.

The plurality of second transmission protrusions 373 may protrude from a lower surface of the output gear 370 toward the input gear 310. The plurality of second transmission protrusions 373 may be spaced apart from each other in a circumferential direction of the output gear 370.

The second transmission protrusions 373 may be located closer to the hole 371 than the gear teeth 372.

Unlike the present embodiment, it is also possible that positions of the input gear 310 and the output gear 370 are reversed. That is, it is also possible that the input gear 310 is located at an upper side of the output gear 370.

Hereinafter, an operation of the clutch gear assembly 300 will be described.

Referring to FIGS. 13A to 14B, in a stopped state of the driver 110, the connection gear 320 is located at the initial position, and when the driver 110 operates, the connection gear 320 may move to a power transmission position or a second position.

In the initial position of the connection gear 320, the first transmission protrusion 327 may be located at a different height from the second transmission protrusion 373. In the initial position of the connection gear 320, the first transmission protrusion 327 and the second transmission protrusion 373 may be spaced apart from each other in the axial direction of the shaft 330. That is, a highest point of the first transmission protrusion 327 may be located lower than a lowest point of the second transmission protrusion 373.

When the driver 110 operates, the connection gear 320 may move, for example, in the axial direction of the shaft 330. Based on FIG. 14A, the connection gear 320 may move upward. When the driver 110 operates, the input gear 310 is rotated.

When the input gear 310 is rotated, positions of the upper end portion 316 and the lower end portion 315 in the first cam portion 314 are varied.

In the initial position of the connection gear 320, the second portion 332 of the shaft 330 is located in the opening 322 of the connection gear 320. At this time, in a state in which the second protrusion 333 is spaced apart from the first protrusion 323, the connection gear 320 may be rotated by a predetermined angle until the second protrusion 333 is in contact with the first protrusion 323. In a state in which the second protrusion 333 is in contact with the first protrusion 323, rotation of the connection gear 320 may be restricted when the input gear 310 is rotated.

In a case where the input gear 310 is rotated while the rotation of the connection gear 320 is restricted, the first cam portion 314 of the input gear 310 may be rotated while contacting the second cam portion 324 of the connection gear 320. At this time, since the upper end portion 316 of the first cam portion 314 moves toward the lower end portion 325 of the second cam portion 324, the connection gear 320 may move toward the output gear 370. That is, the connection gear 320 may move upward.

In the state in which the rotation of the connection gear 320 is restricted, the connection gear 320 may move to the power transmission position or the second position (refer to FIG. 14B).

In a state in which the connection gear 320 is located at the power transmission position, the second portion 332 is located outside the connection gear 320. In addition, the second protrusion 333 moves out from between two adjacent first protrusions 323.

When the second portion 332 is located outside the connection gear 320, the connection gear 320 becomes rotatable.

In the power transmission position of the connection gear 320, a state in which the second cam portion 324 is in contact with the first cam portion 314 may be maintained. Accordingly, the connection gear 320 may be rotated when the input gear 310 is rotated.

In the power transmission position of the connection gear 320, a height of at least a portion of the first transmission protrusion 327 may be equal to a height of the second transmission protrusion 373.

Accordingly, when the connection gear 320 is rotated, at least one of the plurality of first transmission protrusions 327 may be in contact with at least one of the plurality of second transmission protrusions 373. In a state in which the first transmission protrusion 327 is in contact with (or connected to) the second transmission protrusion 373, when the connection gear 320 is rotated, the output gear 370 may also be rotated. That is, in the power transmission position of the connection gear 320, a rotational force of the input gear 310 may be transmitted to the output gear 370 by the connection gear 320. That is, the connection gear 320 may transmit the rotational force of the input gear 310 (or power of the driver) to the output gear 370 in the axial direction. A rotational direction of the connection gear 320 may be the same as a rotational direction of the input gear 310. A rotational direction of the output gear 370 may be the same as the rotational direction of the input gear 310.

Meanwhile, when the operation of the driver 110 is stopped, the connection gear 320 may move to the initial position by an elastic force of the elastic member 350. That is, the connection gear 320 may be moved downward by the elastic force of the elastic member 350. Accordingly, a connection between the connection gear 320 and the output gear 370 may be released.

Hereinafter, a process of opening and closing the door will be described.

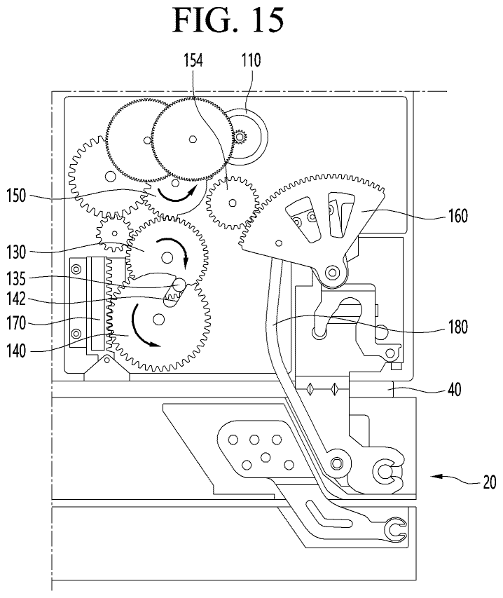

FIGS. 15 to 22 are drawings showing a process of automatically opening a door.

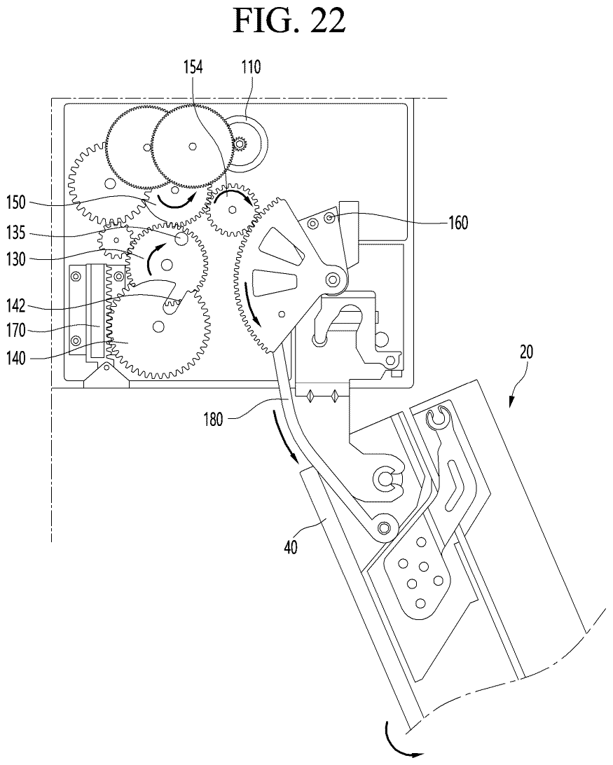

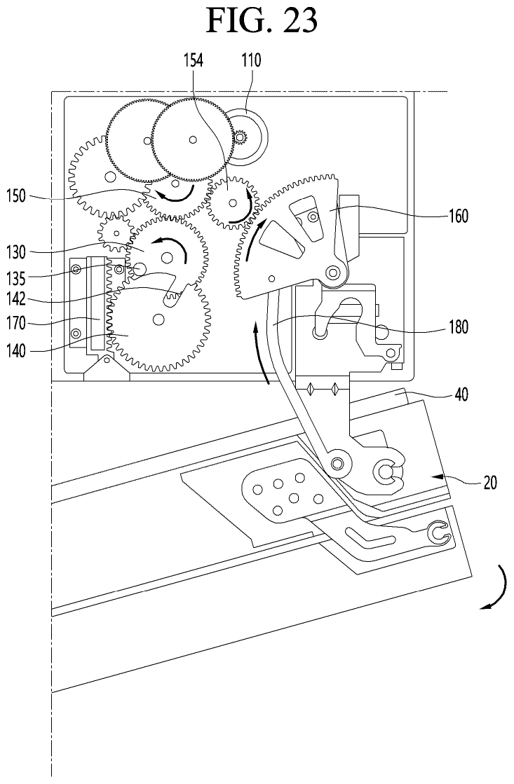

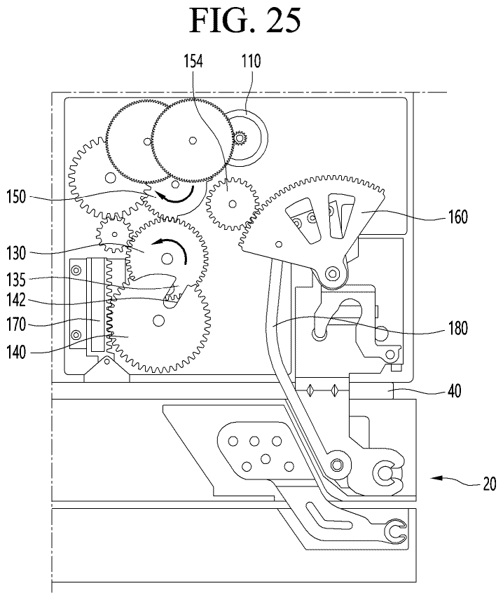

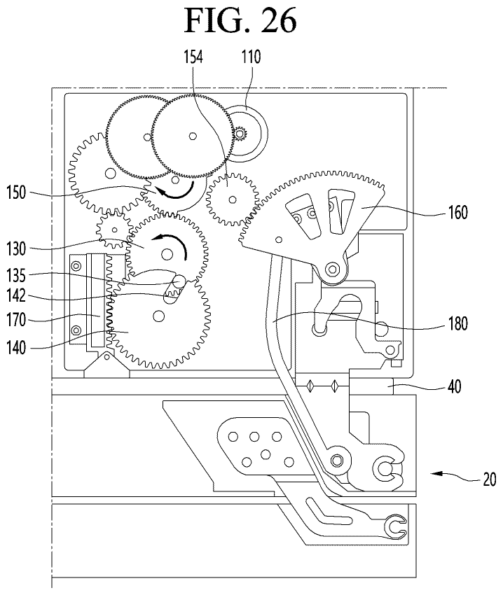

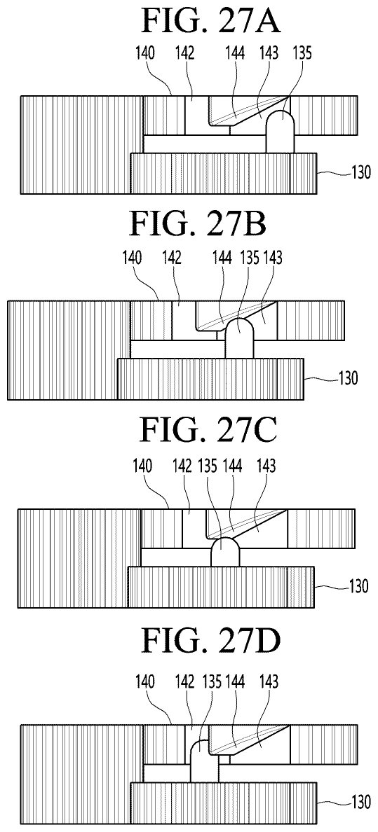

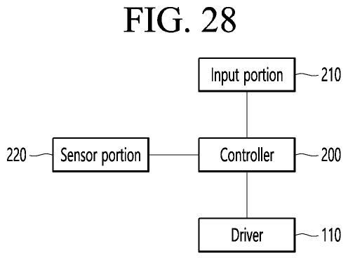

FIGS. 23 to 26 are drawings showing a process of automatically closing a door. FIGS. 27A to 27D are views showing a process in which a moving portion of a fifth gear moves into a slot of a transmission gear while a door is automatically closed. FIG. 28 is a control block diagram of a refrigerator according to a first embodiment.

Referring to FIGS. 3 to 28, a refrigerator of the present embodiment may further include a controller 200. The controller 200 may be installed at or spaced apart from an object for control. The controller 200 may be located inside or outside the object for control.

For example, the controller 200 may be provided at the cabinet 10 or the door 20.

The controller 200 may control the driver 110. The controller 200 may be located outside the driver 110. The controller 200 may control the driver 110 alone, or may also control other components in the refrigerator besides the driver 110.

The refrigerator 1 may further include an input portion 210. The input portion 210 may input a door opening command for opening the door 20.

The input portion 210 may include a touch sensor for detecting a user's touch on a front surface of the door 20, or may include a knock sensor for detecting a plurality of knocks applied to a front surface of the door 20. Alternatively, the input portion 210 may include a capacitive sensor, a vibration detection sensor, or a sound wave detection sensor. Alternatively, the input portion 210 may include a mechanical button or a touch screen through which a user's command may be input. Since the input portion 210 can receive a user's command input or detect a user's command, the input portion 210 may also be referred to as an input detection portion.

The input portion 210 may be provided at the cabinet 10 or the door 20.

The refrigerator 1 may further include a sensor portion 220. The sensor portion 220 may detect opening and closing of the door 20. The sensor portion 220 may be provided at the cabinet 10 or the door 20.

An operation of the driver 110 for automatic opening of the door 20 may be performed in a state in which the door 20 is closed. That is, the driver 110 may operate when an automatic opening command for the door 20 is input while a closed state of the door 20 is detected by the sensor portion 220.

In a state in which the door 20 is closed, the first operating portion 170 and the second operating portion 180 may be located at an initial position. In a state in which the driver 110 is stopped, the connection gear 320 may be located at the initial position.

Referring to FIG. 15, in the initial position of the first operating portion 170, the first operating portion 170 may be spaced apart from a rear surface of the door 20. The transmission gear 140 may be located between the first operating portion 170 and the second operating portion 180. The second operating portion 180 may be located closer to the rotation center C1 of the door 20 than the first operating portion 170.

In the initial position of the second operating portion 180, the second coupling portion 183 may be located farther from the front surface of the cabinet 10 than the first operating portion 170. The driver 110 may be located farther from the front surface of the cabinet 10 than the second coupling portion 183.

### Process of Automatically Opening and Closing the Door

In the state in which the door 20 is closed, a door opening command may be input through the input portion 210. Then, the controller 200 may control the driver 110 for automatic opening of the door 20.

Referring to FIG. 15, the controller 200 may cause the driver 110 to operate in a forward direction. For example, the controller 200 may rotate the motor in the forward direction. When the motor is rotated in the forward direction, power of the motor may be transmitted to the first operating portion 170 through the power transmission portion 120 and the first transmission unit.

When the operation of the driver 110 is stopped, the connection gear 320 is located at the initial position, and when the driver 110 operates in the forward direction, as shown in FIGS. 14A and 14B, the connection gear 320 moves to the power transmission position, so that power transmission to the output gear 370 may be possible.

Accordingly, when the driver 110 operates in the forward direction, power of the driver 110 may be transmitted to the first operating portion 170 by the output gear 370.

In the initial position of the first transmission portion 150, the first transmission portion 150 and the second transmission portion 154 are in a disconnected state. Therefore, even if the driver 110 operates in the forward direction and the first transmission portion 150 is rotated, the second transmission portion 154 maintains a stopped state. In the state in which the second transmission portion 154 is stopped, the third transmission portion 160 and the second operating portion 180 also maintain a stopped state.

For the operation of the first operating portion 170, the fifth gear 130 may be rotated in one direction (clockwise on the drawing), and the transmission gear 140 may be rotated in the other direction (counterclockwise on the drawing). When the transmission gear 140 is rotated in the other direction, the first operating portion 170 moves from an initial position toward an end position in a first direction (for example, a front-back direction) (a door opening direction).

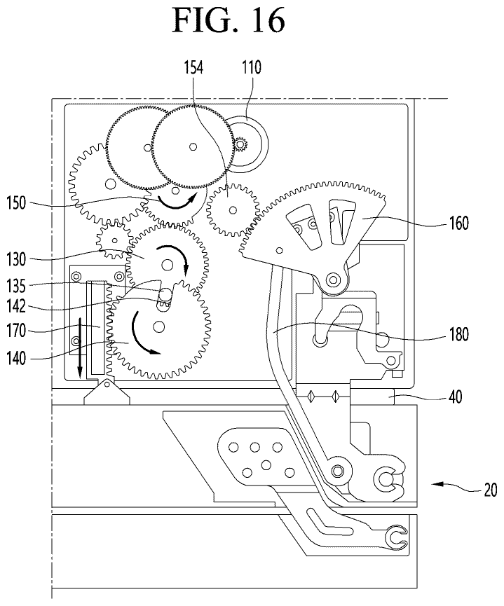

As shown in FIG. 16, when the first operating portion 170 moves in the first direction, the first operating portion 170 may be in contact with the rear surface of the door 20. Even in a state in which the first operating portion 170 is in contact with the rear surface of the door 20, the second operating portion 180 maintains a stopped state.

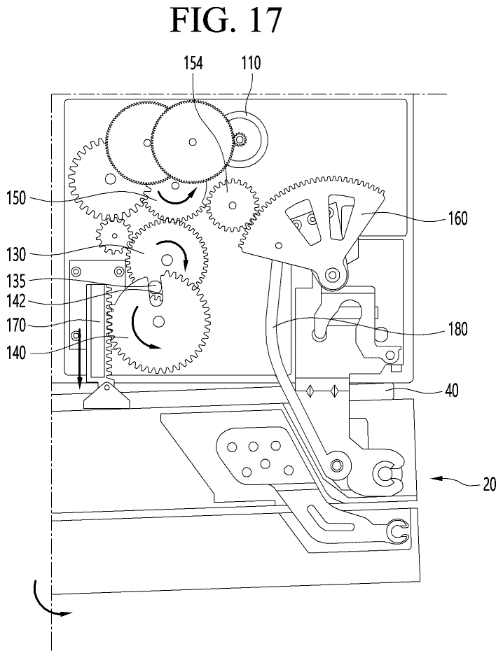

As shown in FIG. 17, when the first operating portion 170 additionally moves in the first direction, the first operating portion 170 pushes the door 20 so that the door 20 is automatically rotated in an opening direction. Accordingly, at least a portion of the gasket 40 begins to be spaced apart from the cabinet 10.

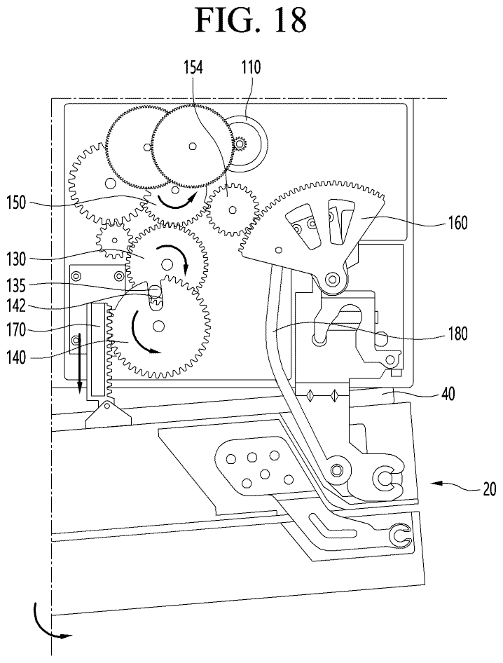

As shown in FIG. 18, when the first operating portion 170 additionally moves in the first direction, the door 20 is further rotated in the opening direction so that the gasket 40 is completely separated from the cabinet 10.

In the present embodiment, the first operating portion 170 operates so that the gasket 40 is separated from the cabinet 10 at an initial stage of the automatic opening of the door 20.

The second operating portion 180 may remain inoperative until the gasket 40 is completely separated from the cabinet 10 by the operation of the first operating portion 170. Alternatively, the second operating portion 180 may operate after a portion of the gasket 40 is separated from the cabinet 10. In either case, the second operating portion 180 may operate after a set time has elapsed or after the first operating portion 170 has moved a set distance following the operation of the first operating portion 170.

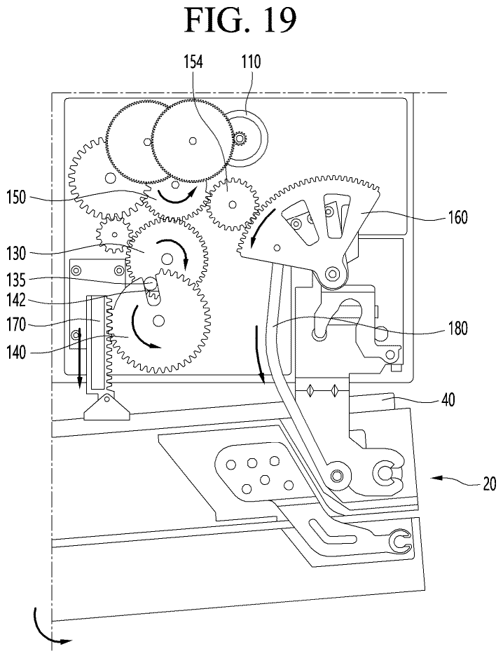

Referring to FIG. 19, even after a portion of the gasket 40 is separated from the cabinet 10, the first operating portion 170 may additionally move in the first direction. In a state as shown in FIG. 19, the first transmission portion 150 may be engaged with the second transmission portion 154, so that the second transmission portion 154 may be rotated.

When the automatic opening of the door 20 starts and the first transmission portion 150 is rotated by an angle equal to or greater than a predetermined angle, the second portion 150b may be engaged with the second transmission portion 154, so that a rotational force of the first transmission portion 150 may be transmitted to the second transmission portion 154. When the second transmission portion 154 is rotated, the third transmission portion 160 is also rotated, so that the second operating portion 180 moves in a door opening direction. After the second operating portion 180 starts to operate, an opening angle of the door 20 may be increased.

The second operating portion 180 may move from an initial position to a door open position in the door opening direction. The second operating portion 180 may move from the door open position to the initial position in a door closing direction.

In a process in which the second operating portion 180 moves in the door opening direction, the door 20 is spaced apart from the first operating portion 170. In a state in which the first operating portion 170 and the door 20 are spaced apart from each other, the first operating portion 170 can no longer apply force to the door 20.

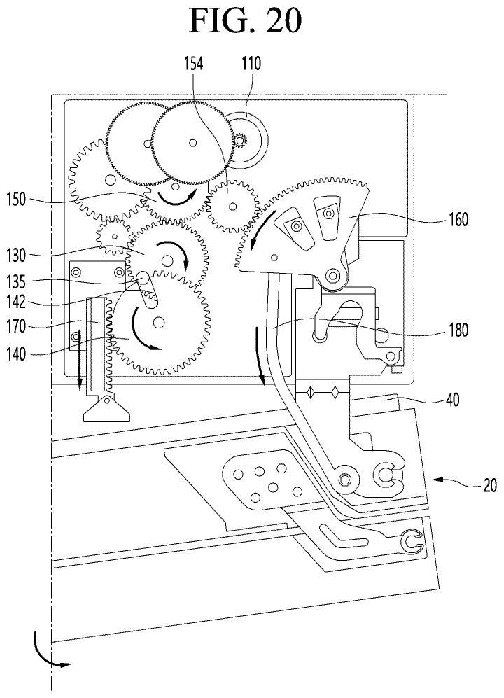

As shown in FIGS. 19 and 20, in some portions of the auto opening process of the door 20, the first operating portion 170 may operate together with the second operating portion 180. That is, the first operating portion 170 may move in the first direction toward the end position, and the second operating portion 180 may move to the door open position.

In the auto opening process of the door 20, the fifth gear 130 may be rotated only in one direction. As shown in FIG. 20, in a state in which the moving portion 135 of the fifth gear 130 is received in the slot 142 of the transmission gear 140, the transmission gear 140 is rotated in the other direction when the fifth gear 130 is rotated in the one direction.

While the transmission gear 140 is rotated in the other direction, the first operating portion 170 moves in the first direction.

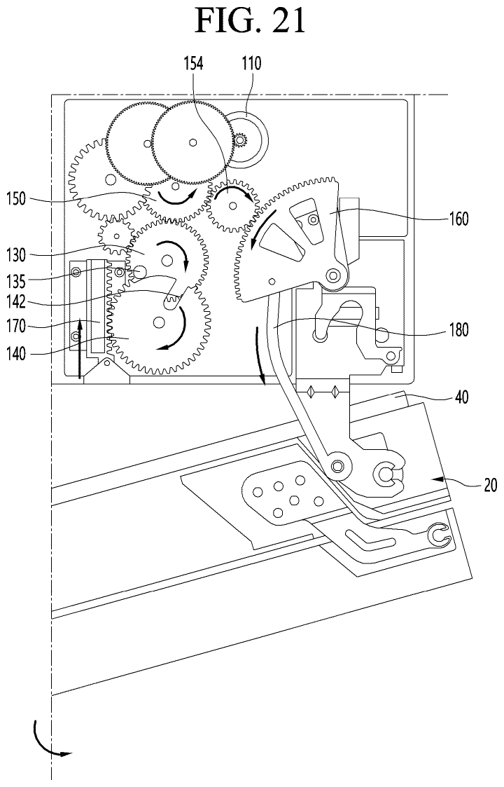

Referring to FIG. 21, during the rotation of the fifth gear 130 in the one direction, the moving portion 135 may be removed from the slot 142 of the transmission gear 140. A point in time when the moving portion 135 is removed from the slot 142 of the transmission gear 140 may be the end position of the first operating portion 170.

When the moving portion 135 is removed from the slot 142 of the transmission gear 140, the rotational force of the fifth gear 130 is not transmitted to the transmission gear 140. That is, a connection between the fifth gear 130 and the transmission gear 140 may be released.

Accordingly, the transmission gear 140 is rotated in one direction by an elastic force of the elastic body 149 to return to the initial position.

In a process in which the transmission gear 140 is rotated in the one direction, the first operating portion 170 moves in a second direction from the end position to the initial position.

Referring to FIG. 22, when the second operating portion 180 continuously moves in the door opening direction and reaches the door open position, the opening angle of the door 20 becomes a maximum. In the present embodiment, the maximum opening angle of the door 20 may be greater than 90 degrees.

When the maximum opening angle of the door 20 is 90 degrees or more, there is an advantage in that a user can easily access the storage space 12 even without manually opening the door 20 further.

Meanwhile, after the automatic opening of the door 20 is completed, the driver 110 may be stopped before the automatic closing of the door 20.

When the driver 110 is stopped, the connection gear 320 may return to the initial position by the elastic force of the elastic member 350. That is, the connection between the connection gear 320 and the output gear 370 may be released.

In a state in which the connection between the connection gear 320 and the output gear 370 is released, a user may manually close the door 20, and in a process in which the door 20 is manually closed, transmission of a closing force of the door 20 to the driver 110 may be blocked. Accordingly, after the automatic opening of the door 20, a phenomenon in which the driver 110 or gears are damaged during the process of the user manually closing the door 20 is prevented, and there is an advantage in that the door 20 can be smoothly closed.

After the automatic opening of the door 20 is completed and in a state in which the driver 110 is in a stopped state, for the automatic closing of the door 20, the controller 200 may cause the driver 110 to operate in a reverse direction when a closing command for the door 20 is detected or recognized, such as when a set time has elapsed after the door 20 is opened, when a user is not detected after the door 20 is opened, or when a separate door closing command is input. That is, the controller 200 may control the motor to rotate in a reverse direction.

When the motor is rotated in the reverse direction, as shown in FIGS. 14A and 14B, the connection gear 320 moves to the power transmission position, so that the connection gear 320 may be connected to the output gear 370.

When the motor is rotated in the reverse direction, power of the motor is transmitted to the second transmission unit so that the second operating portion 180 may move from the door open position to the initial position in the door closing direction.

Since the connection between the fifth gear 130 and the transmission gear 140 is released during the process of opening the door 20, the first operating portion 170 and the transmission gear 140 maintain a stopped state while the motor is rotated in the reverse direction.

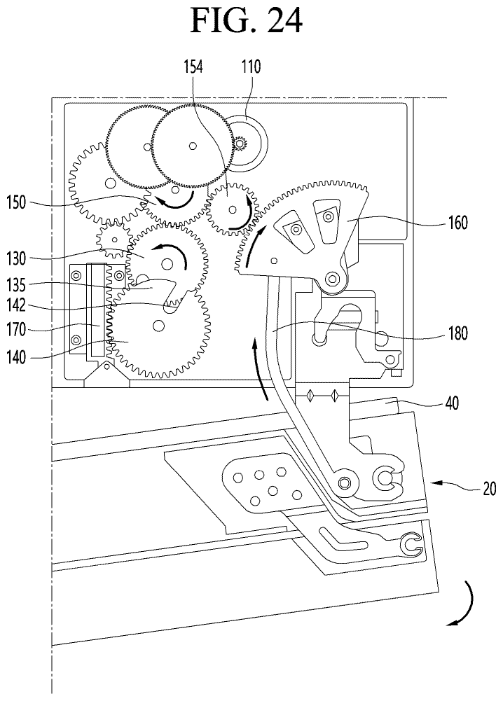

Referring to FIGS. 24 to 28, during a process in which the motor is rotated in the reverse direction, the fifth gear 130 is rotated in the other direction.

During the process in which the fifth gear 130 is rotated in the other direction, the moving portion 135 may be aligned with the recess 143 as shown in FIG. 27A. When the fifth gear 130 is additionally rotated in the other direction, the moving portion 135 is in contact with the inclined surface 144 within the recess 143. Referring to FIGS. 27B and 27C, during the rotation of the fifth gear 130 in the other direction, the moving portion 135 is pressed by the inclined surface 144 and moves downward. When the moving portion 135 moves downward, the elastic member 148 may be contracted. Thereafter, referring to FIG. 27D, when the moving portion 135 is aligned with the slot 142, the elastic member 148 is extended, and the moving portion 135 is inserted into the slot 142 by an elastic force of the elastic member 148. The motor may be stopped at a point in time when the moving portion 135 is inserted into the slot 142 or after the moving portion 135 is inserted into the slot 142.

According to the present embodiment, at an initial stage of the automatic opening of the door, power of the motor is transmitted to the first operating portion and is used for separation of the gasket, and during or after a separation process of the gasket, the power is used as an opening force of the door. Therefore, there is an advantage in that the gasket of the door can be easily separated at the initial stage of the door opening.

Also, in the case of the present embodiment, the door is not only automatically opened but also automatically closed, so that convenience of a user is improved.

In addition, in the case of the present embodiment, when the driver is stopped after the door is automatically opened or while the driver is operating, power transmission to the driver is blocked by a clutch gear assembly. Accordingly, damage to the driver or gears is prevented during manual opening of the door, and there is an advantage in that the door can be smoothly closed.

### Process of Manually Opening the Door

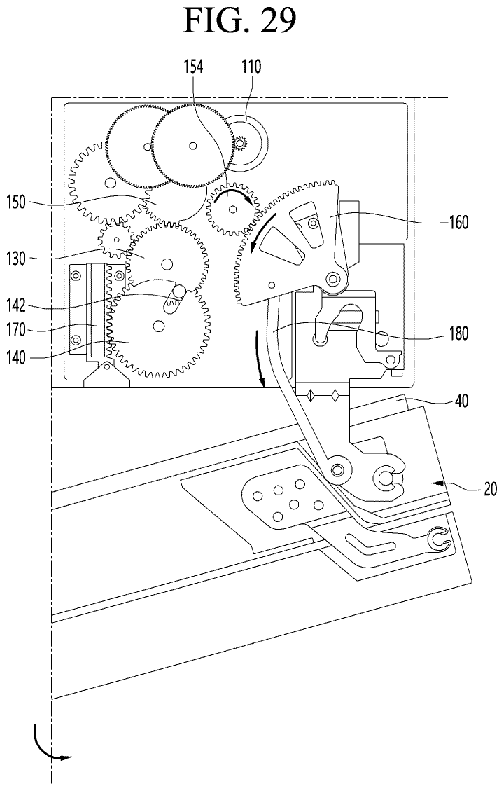

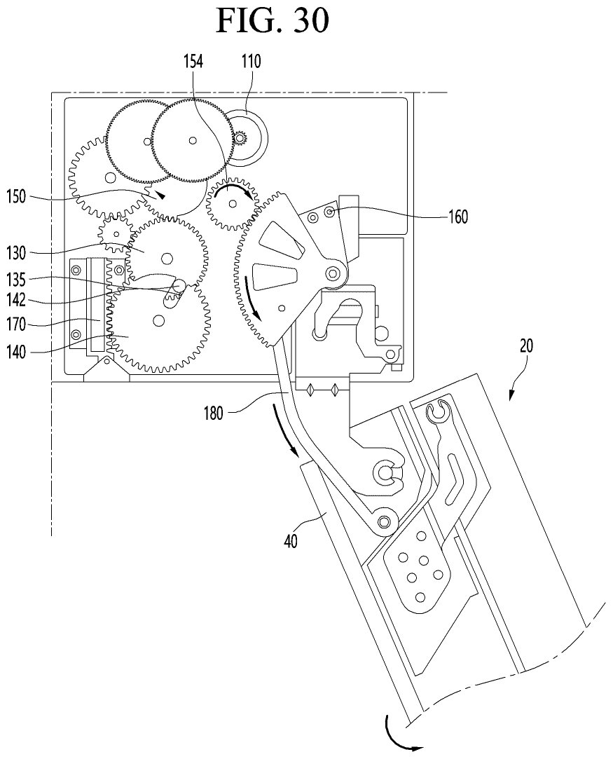

FIGS. 29 and 30 are drawings showing a process of manually opening a door.

Referring to FIGS. 29 and 30, a user may manually open the door 20 in a state in which the door 20 is closed.

As described above, in the state in which the door 20 is closed, the first transmission portion 150 and the second transmission portion 154 are in a disconnected state, so that rotation of the first transmission portion 150 is restricted even if the second transmission portion 154 is rotated. In the disconnected state of the first transmission portion 150 and the second transmission portion 154, the first transmission portion 150 may be located at a disconnected position.

When a user grips a handle of the door 20 and pulls the door 20, the door 20 may be rotated. When the door 20 is rotated in an opening direction, the second operating portion 180 connected to the door 20 moves together with the door 20. In the process of manually opening the door 20, the second operating portion 180 may move to a door open position by a rotational force of the door 20.

When the second operating portion 180 moves together with the door 20, the third transmission portion 160 connected to the second operating portion 180 is rotated. When the third transmission portion 160 is rotated, the second transmission portion 154 is also rotated. However, since the first transmission portion 150 is located at the disconnected position, the first transmission portion 150 is not rotated even if the second transmission portion 154 is rotated. Accordingly, in the process of manually opening the door 20, a manual rotational force of the door 20 is not transmitted to the first transmission portion 150. Since the rotational force of the door 20 is also not transmitted to the driver 110, applying a load to the driver 110 can be prevented. In addition, since the rotational force of the door 20 is not transmitted to the first transmission unit and the power transmission portion 120 during the manual opening process of the door 20, damage to gears can be prevented, and generation of noise due to rotation of the gears can be prevented.

Even in a process in which the user closes the door 20, the second transmission portion 154 rotates, but the first transmission portion 150 may maintain a stopped state.

Meanwhile, considering the weight of the door or the strength of magnetic force of a magnet, it is also possible to omit the first transmission unit and the first operating portion.

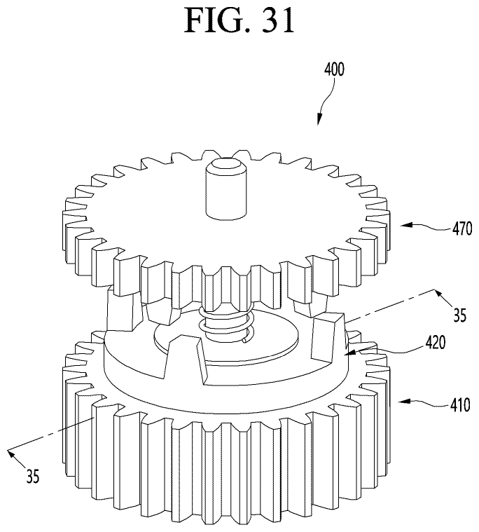

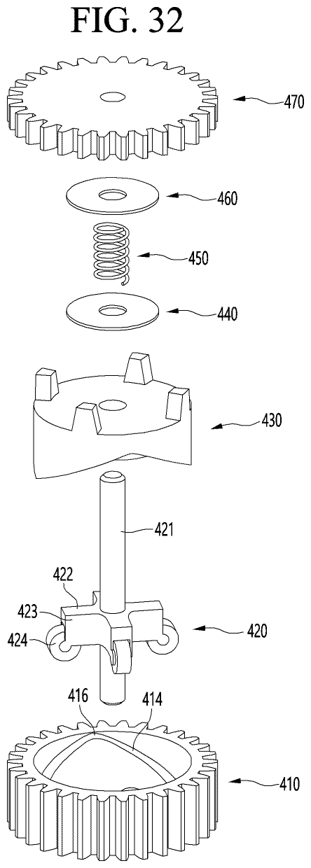

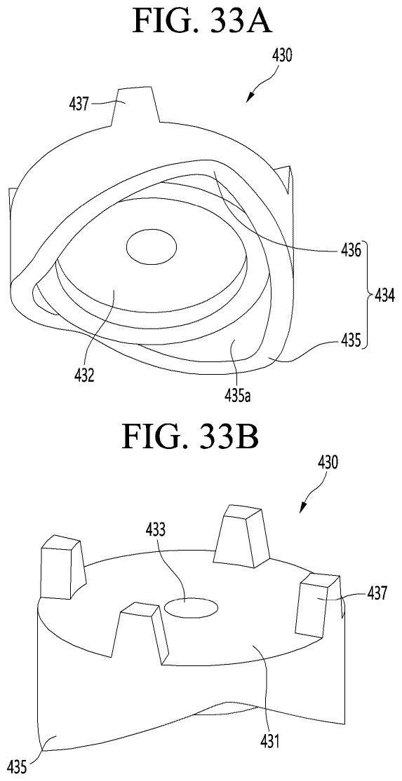

FIG. 31 is a perspective view showing a clutch gear assembly according to a second embodiment. FIG. 32 is an exploded perspective view of a clutch gear assembly according to a second embodiment. FIGS. 33A and 33B are perspective views of a connection gear according to a second embodiment. FIG. 34 is a perspective view of an output gear according to a second embodiment.

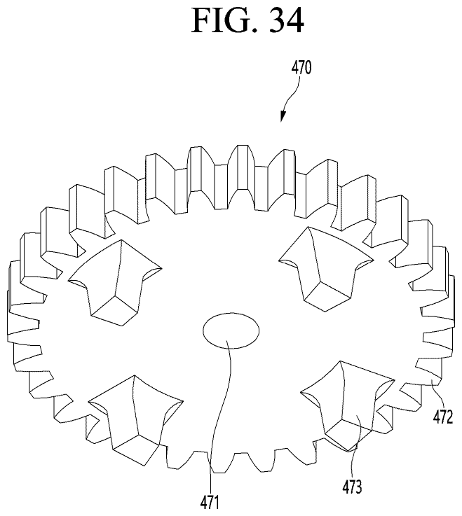

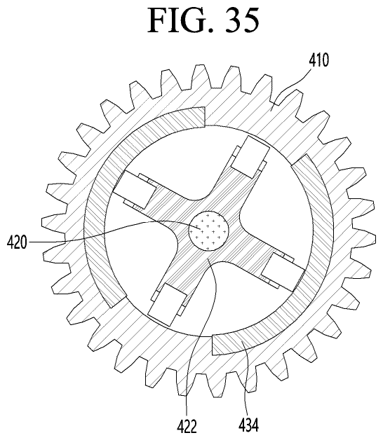

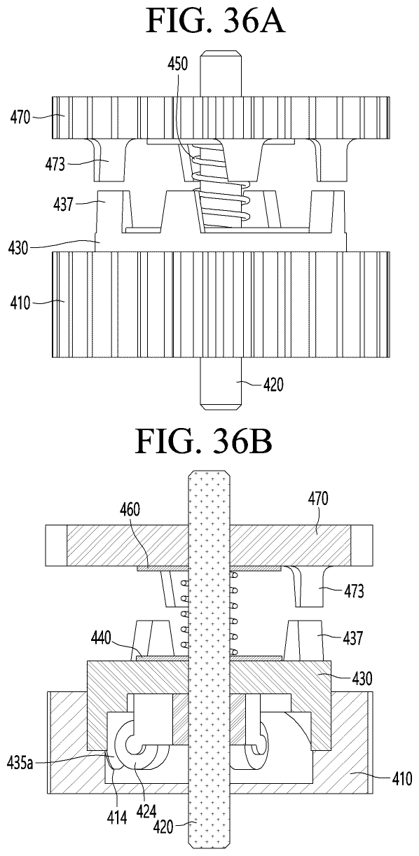

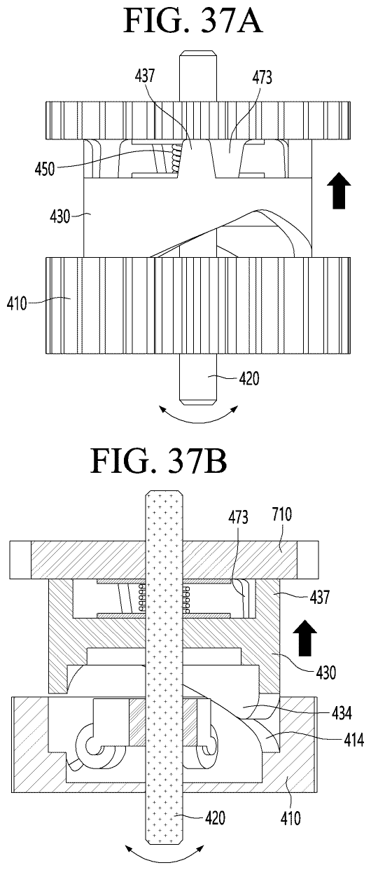

FIG. 35 is a cross-sectional view taken along line 35-35 of FIG. 32. FIGS. 36A and 36B are views showing a clutch gear assembly in a stopped state of a driver according to a second embodiment. FIGS. 37A and 37B are drawings showing a clutch gear assembly when a driver operates according to a second embodiment.

FIGS. 36A and 37A show front views of a clutch gear assembly, and FIGS. 36B and 37B show cross-sectional views of the clutch gear assembly.

The present embodiment is identical to the first embodiment in other respects, except that it differs a structure of the clutch gear assembly. Therefore, hereinafter, only characteristic portions of the present embodiment will be described.

Referring to FIGS. 31 to 37B, a clutch gear assembly 400 of the present embodiment may include an input gear 410, a connection gear 430, and an output gear 470.

Basic functions and operations of the input gear 410, the connection gear 430, and the output gear 470 are the same as those of the input gear 310, the connection gear 320, and the output gear 370 of the first embodiment.

The clutch gear assembly 400 may further include a shaft 430 that rotatably supports the input gear 410.

The input gear 410 may be rotated during operation of the driver 110. The input gear 410 may maintain a state of being connected to the driver 110.

The shaft 430 may be coupled to pass through the input gear 410. The shaft 430 may be a fixed shaft. The shaft 430 may be fixed to a frame 101 of the door opening and closing device 100.

The clutch gear assembly 400 may further include an elastic member 450 for providing an elastic force to the connection gear 430.

Hereinafter, each component of the clutch gear assembly 400 will be described in more detail.

The input gear 410 may include a first cam portion 414. Since a shape of the input gear 410 may be the same as or similar to the shape of the input gear 310 of the first embodiment, a detailed description thereof will be omitted.

The first cam portion 414 may include two or more lower end portions 415 (or first ends) and two or more upper end portions 416 (or second ends), identically to what was described in the first embodiment.

The shaft 420 may include a first portion 421 and a second portion 422 coupled to or integrally formed with the first portion 421. The second portion 422 may include a plurality of arms 423 extending in a radial direction of the first portion 421. The plurality of arms 423 may be arranged to be spaced apart from each other in a circumferential direction.

A bearing 424 may be rotatably coupled to each of the plurality of arms 423. A portion of the bearing 424 may protrude from the arm 423. The bearing 424 may be rotated with respect to a rotation center extending in a direction crossing an extension direction of the shaft 420. For example, a rotation center line of the bearing 424 may extend in a horizontal direction.

The bearing 424 may restrict rotation of the connection gear 430 in a state of being in contact with the connection gear 430, and may allow the connection gear 430 to move in an axial direction of the shaft 420.

The connection gear 430 may include a body 431 having a hole 433 formed in a central portion thereof for the shaft 430 to pass through.

The body 431 may include a second cam portion 434 that interacts with the first cam portion 414.

The second cam portion 434 may include two or more lower end portions 435 (or first ends) and two or more upper end portions 436 (or second ends). The lower end portions 435 and the upper end portions 436 may be alternately arranged.

For example, the lower end portion 435 may be formed by a protrusion 435a protruding downward from the body 431. The upper end portion 436 may be formed by a recess in which one surface of the body 431 is recessed upward.

The body 431 may further include a receiving portion 432 in which the second portion 422 of the shaft 420 may be received.

The connection gear 430 may be received in the input gear 410 at an initial position.

At the initial position of the connection gear 430, a portion of the second portion 422 of the shaft 420 may be located in the receiving portion 432 of the connection gear 430.

At the initial position of the connection gear 430, at least one of the plurality of bearings 424 may be in contact with the second cam portion 434 of the connection gear 430. For example, the at least one of the plurality of bearings 424 may be in contact with an inner surface of a protrusion 435a including the lower end portion 435 in the second cam portion 434 (refer to FIG. 36B). On the other hand, all of the plurality of bearings 424 may not be in contact with the input gear 410. Accordingly, the input gear 410 is rotatable without interference with the bearings 424.

During rotation of the input gear 410, the bearing 424 may restrict rotation of the connection gear 430 until the bearing 424 is not in contact with the second cam portion 434. On the other hand, the bearing 424 may allow upward movement of the connection gear 430 until the bearing 424 is not in contact with the second cam portion 434.

The connection gear 430 may include a plurality of first transmission protrusions 437 protruding from the body 431 toward the output gear 470. The plurality of first transmission protrusions 437 may be arranged to be spaced apart from each other in a circumferential direction.

The clutch gear assembly 400 may further include a first washer 440. The first washer 440 may be seated on the body 431. For example, the first washer 440 may be seated on an upper surface of the body 431.

The clutch gear assembly 400 may further include a second washer 460. The second washer 460 may be in contact with a lower surface of the output gear 470.

The first portion 421 of the shaft 420 may pass through the connection gear 430, the first washer 440, the second washer 460, and the output gear 470.

One end of the elastic member 450 may be supported by the first washer 440, and the other end thereof may be supported by the second washer 460. Of course, it is also possible that one or more of the first washer 440 and the second washer 460 are omitted, and the elastic member 450 is supported by one or more of the connection gear 430 and the output gear 470.

The elastic member 450 may be, for example, a coil spring. The elastic member 450 may be arranged to surround the first portion 421 of the shaft 420.

The output gear 470 may include a hole 471 through which the first portion 421 of the shaft 420 passes.

The output gear 470 may include a plurality of gear teeth 472. The output gear 470 may include a plurality of second transmission protrusions 473 capable of interacting with the plurality of first transmission protrusions 437.

The plurality of second transmission protrusions 473 may protrude from the lower surface of the output gear 470 toward the input gear 410. The plurality of second transmission protrusions 473 may be spaced apart from each other in a circumferential direction of the output gear 470.

The second transmission protrusions 473 may be located closer to the hole 471 than the gear teeth 472.

Hereinafter, an operation of the clutch gear assembly 400 will be described.

Referring to FIGS. 36 and 37, in a stopped state of the driver 110, the connection gear 430 is located at an initial position, and when the driver 110 is operated, the connection gear 430 may move to a power transmission position or a second position.

At the initial position of the connection gear 430, the first transmission protrusion 437 may be located at a different height from the second transmission protrusion 473. That is, a highest point of the first transmission protrusion 437 may be located lower than a lowest point of the second transmission protrusion 473.

When the driver 110 is operated, the connection gear 430 may move, for example, in an axial direction of the shaft 420. Based on FIG. 37, the connection gear 430 may move upward.

When the driver 110 is operated, the input gear 410 is rotated. When the input gear 410 is rotated, positions of the upper end portion 415 and the lower end portion 416 in the first cam portion 414 are varied.

At the initial position of the connection gear 430, since one or more of the bearings 424 may be in contact with the second cam portion 434, rotation of the connection gear 430 may be restricted when the input gear 410 is rotated.

In a case in which the input gear 410 is rotated while the rotation of the connection gear 430 is restricted, the first cam portion 414 of the input gear 410 may be rotated while contacting the second cam portion 434 of the connection gear 430. At this time, since the upper end portion 416 of the first cam portion 414 moves toward the lower end portion 435 of the second cam portion 434, the connection gear 430 may move toward the output gear 470 in a state in which the rotation thereof is restricted. That is, the connection gear 430 may move upward.

In the state in which the rotation of the connection gear 430 is restricted, the connection gear 430 may move to a power transmission position or a second position (refer to FIGS. 37A and 37B).

In a state in which the connection gear 430 is located at the power transmission position, all of the plurality of bearings 424 do not contact the second cam portion 434 of the connection gear 430. That is, all of the plurality of bearings 424 are spaced apart from the second cam portion 434 of the connection gear 430.

When the plurality of bearings 424 are spaced apart from the second cam portion 434 of the connection gear 430, the connection gear 430 becomes in a rotatable state.

At the power transmission position of the connection gear 430, the first cam portion 414 may maintain a state of being in contact with the second cam portion 434. Accordingly, the connection gear 430 may be rotated when the input gear 410 is rotated.

At the power transmission position of the connection gear 430, a height of at least a portion of the first transmission protrusion 437 may be the same as a height of the second transmission protrusion 473.

Accordingly, when the connection gear 430 is rotated, the first transmission protrusion 437 may be in contact with the second transmission protrusion 473. In a state in which the first transmission protrusion 437 is in contact with (or connected to) the second transmission protrusion 473, the output gear 470 may also be rotated when the connection gear 430 is rotated. That is, at the power transmission position of the connection gear 430, a rotational force of the input gear 410 may be transmitted to the output gear 470 by the connection gear 430.

Meanwhile, when operation of the driver 110 is stopped, the connection gear 430 may move to the initial position by an elastic force of the elastic member 450. That is, the connection gear 430 may be moved downward by the elastic force of the elastic member 450. Accordingly, the connection between the connection gear 430 and the output gear 470 may be released.

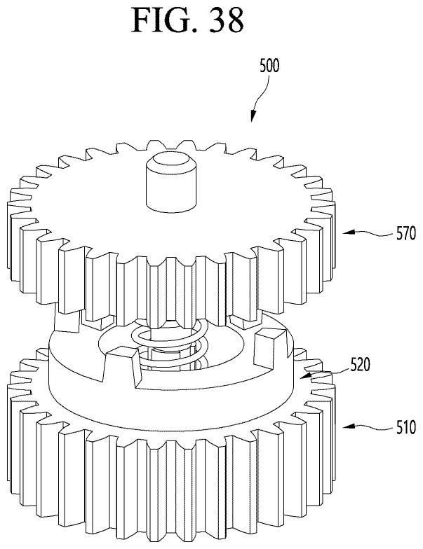

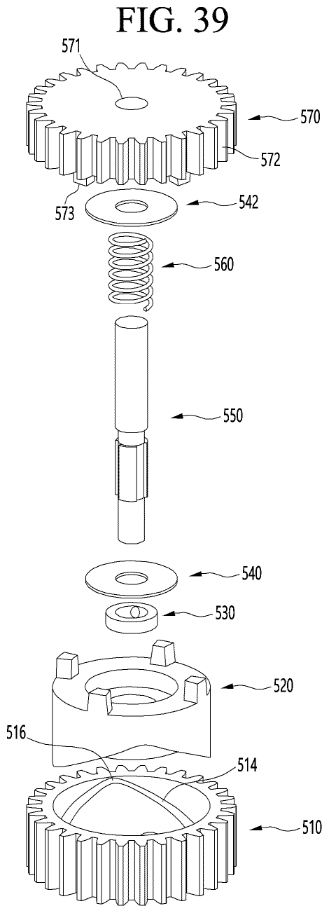

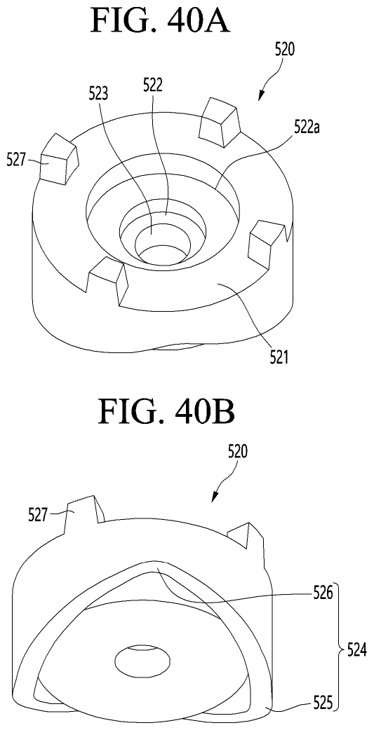

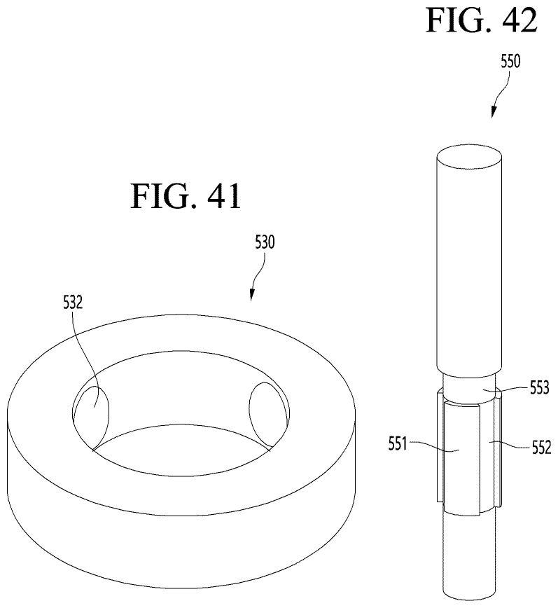

FIG. 38 is a perspective view showing a clutch gear assembly according to a third embodiment. FIG. 39 is an exploded perspective view of a clutch gear assembly according to a third embodiment. FIGS. 40A and 40B are perspective views of a connection gear according to a third embodiment. FIG. 41 is a perspective view of a bearing member according to a third embodiment. FIG. 42 is a perspective view of a shaft according to a third embodiment.

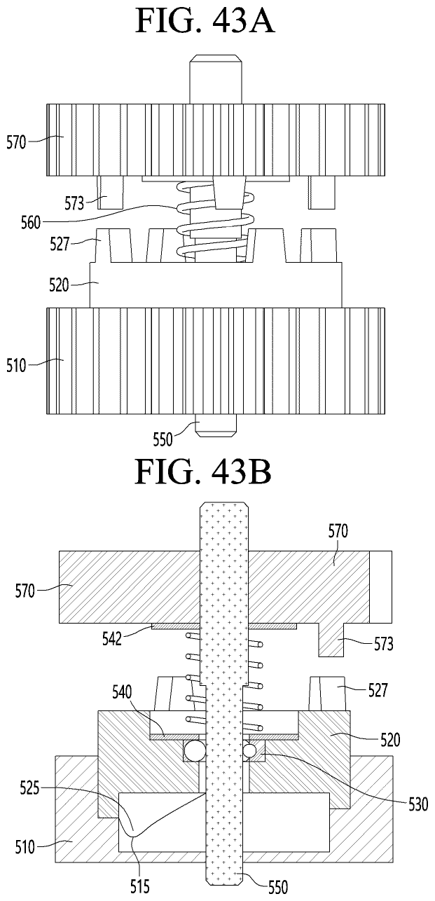

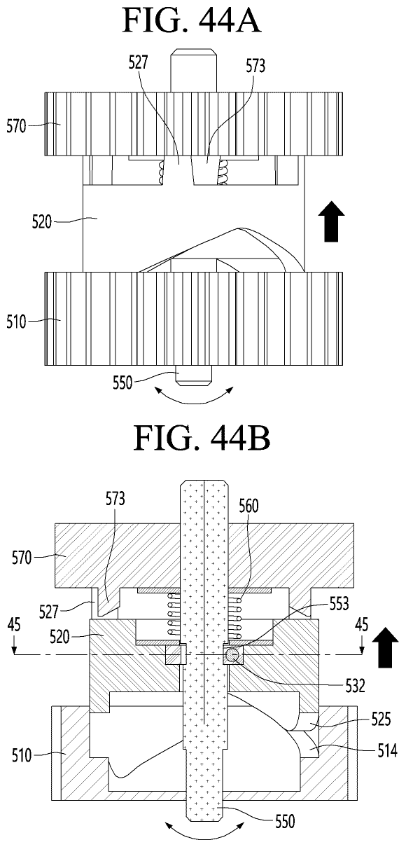

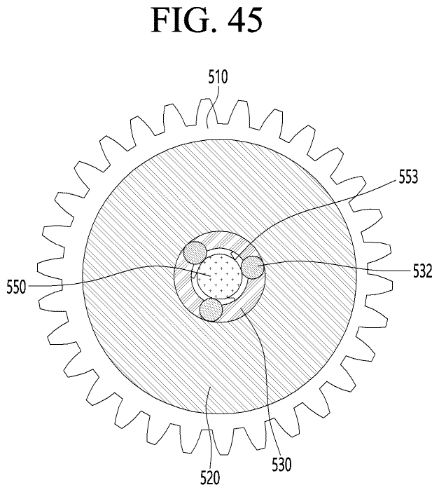

FIGS. 43A and 43B are drawings showing a clutch gear assembly in a stopped state of a driver according to a third embodiment. FIGS. 44A and 44B are drawings showing a clutch gear assembly when a driver operates according to a third embodiment.

FIG. 45 is a cross-sectional view taken along line 45-45 of FIG. 44B.

This embodiment is identical to the first embodiment in other respects, except that it differs a structure of the clutch gear assembly. Therefore, hereinafter, only the characteristic portions of the present embodiment will be described.

Referring to FIGS. 38 to 45, a clutch gear assembly 500 of the present embodiment may include an input gear 510, a connection gear 520, and an output gear 470.

Basic functions and operations of the input gear 510, the connection gear 520, and the output gear 570 are the same as those of the input gear 310, the connection gear 320, and the output gear 370 of the first embodiment.

The clutch gear assembly 500 may further include a shaft 550 that rotatably supports the input gear 510.

The clutch gear assembly 500 may further include a bearing member 530. The bearing member 530 may be coupled to the connection gear 520.

The input gear 510 may be rotated during operation of the driver 110. The input gear 510 may maintain a state of being connected to the driver 110.

The shaft 550 may be coupled to pass through the input gear 510. The shaft 550 may be a fixed shaft. The shaft 550 may be fixed to a frame 101 of the door opening and closing device 100.

The clutch gear assembly 500 may further include an elastic member 560 for providing an elastic force to the connection gear 520.

Hereinafter, each component of the clutch gear assembly 500 will be described in more detail.

The input gear 510 may include a first cam portion 514. Since the shape of the input gear 510 may be the same as or similar to the shape of the input gear 310 of the first embodiment, a detailed description thereof will be omitted.

The first cam portion 514 may include two or more lower end portions 515 (or first ends) and two or more upper end portions 516 (or second ends), identically to what was described in the first embodiment.

The connection gear 520 may include a body 521 having a hole 523 formed in a central portion thereof for the shaft 550 to pass through.

The body 521 may include a second cam portion 524 that interacts with the first cam portion 514.

The second cam portion 524 may include two or more lower end portions 525 (or first ends) and two or more upper end portions 526 (or second ends). The lower end portions 525 and the upper end portions 526 may be alternately arranged.

For example, the lower end portion 525 may be formed by a protrusion protruding downward from the body 521. The upper end portion 526 may be formed by a recess in which one surface of the body 521 is recessed upward.

The body 521 may further include a bearing receiving portion 522 in which the bearing member 530 is received. The bearing member 530 may be formed in a ring shape. The bearing member 530 may move together with the connection gear 520 in a state of being received in the bearing receiving portion 522. The hole 523 may pass through a bottom of the bearing receiving portion 522.

The body 521 may further include a washer receiving portion 522a in which a first washer 540, to be described later, is received. The washer receiving portion 522a may be formed as an upper surface of the body 521 is recessed toward the input gear 510.

For example, the bearing receiving portion 522 may be formed as a bottom of the washer receiving portion 522a is recessed toward the input gear 510. A diameter of the washer receiving portion 522a may be greater than a diameter of the bearing receiving portion 522. Accordingly, when the first washer 540 is seated in the washer receiving portion 522a, the first washer 540 may cover the bearing member 530.

Although not limited, the first washer 540 may be in contact with the bearing member 530. Accordingly, the first washer 540 may prevent the bearing member 530 from being separated from the bearing receiving portion 522.

Of course, it is also possible that the washer receiving portion 522a is omitted and the first washer 540 is seated on an upper surface of the body 521.

The connection gear 520 may include a plurality of first transmission protrusions 527 protruding from the body 521 toward the output gear 570. The plurality of first transmission protrusions 527 may be arranged to be spaced apart from each other in a circumferential direction.

The bearing member 530 may be formed in a ring shape, and the shaft 550 may pass through a central portion thereof. The bearing member 530 may include a plurality of ball bearings 532. Each ball bearing 532 may protrude from an inner circumferential surface of the bearing member 530 toward a center portion.

The shaft 550 may include a body 551 having the same diameter or a variable diameter in an axial direction.

The shaft 550 may include a first slot 552 in which the ball bearing 532 may be located. The first slot 552 may be formed by being recessed from the body 551. The first slot 552 may extend in an axial direction of the shaft 550. For example, the first slot 552 may extend in a vertical direction, which is one direction.

A plurality of first slots 552 may be spaced apart from each other in a circumferential direction of the shaft 550. A number of the plurality of first slots 552 is the same as a number of the plurality of ball bearings 532.

The shaft 550 may further include a second slot 553 in which the ball bearing 532 may be located. The second slot 553 may extend in another direction that crosses an extension direction of the first slot 552.

For example, the second slot 553 may be formed by being recessed from the body 551. The second slot 553 may extend in a circumferential direction of the shaft 550.

The plurality of first slots 552 may communicate with the second slot 553. Based on FIG. 42, the second slot 553 may be located at an upper side of the first slots 552.

In a state in which the ball bearing 532 is located in the first slot 552, rotation of the connection gear 520 may be restricted. In a state in which the ball bearing 532 is located in the second slot 553, the connection gear 520 may be rotated.

The connection gear 520 may be received in the input gear 410 at an initial position.

The clutch gear assembly 500 may further include a first washer 540. The first washer 540 may be received in the washer receiving portion 522a.

The clutch gear assembly 500 may further include a second washer 542. The second washer 542 may be in contact with a lower surface of the output gear 570.

A body 551 of the shaft 550 may pass through the connection gear 520, the bearing member 530, the first washer 540, the second washer 542, and the output gear 570.

One end of the elastic member 560 may be supported by the first washer 540, and the other end may be supported by the second washer 542. Of course, it is also possible that one or more of the first washer 540 and the second washer 542 are omitted, and the elastic member 560 is supported by at least one of the bearing member 530 or the output gear 570.

The elastic member 560 may be, for example, a coil spring. The elastic member 560 may be arranged to surround the shaft 550.

The output gear 570 may include a hole 571 through which the shaft 550 passes.

The output gear 570 may include a plurality of gear teeth 572. The output gear 570 may include a plurality of second transmission protrusions 573 capable of interacting with the first transmission protrusions 527.

The plurality of second transmission protrusions 573 may protrude from a lower surface of the output gear 570 toward the input gear 510. The plurality of second transmission protrusions 573 may be spaced apart from each other in a circumferential direction of the output gear 570.

The second transmission protrusions 573 may be located closer to the hole 571 than the gear teeth 572.

Hereinafter, an operation of the clutch gear assembly 500 will be described.

Referring to FIGS. 43A to 45, in a stopped state of the driver 110, the connection gear 520 is located at an initial position, and when the driver 110 is operated, the connection gear 520 may move to a power transmission position or a second position.

At the initial position of the connection gear 520, the first transmission protrusion 527 may be located at a different height from the second transmission protrusion 573. That is, a highest point of the first transmission protrusion 527 may be located lower than a lowest point of the second transmission protrusion 573.

When the driver 110 is operated, the connection gear 520 may move, for example, in an axial direction of the shaft 550. Based on FIG. 44A, the connection gear 520 may move upward.

When the driver 110 is operated, the input gear 510 is rotated. When the input gear 510 is rotated, positions of the upper end portion 515 and the lower end portion 516 in the first cam portion 514 are varied.

At the initial position of the connection gear 520, since the ball bearings 532 are located in the first slots 552, rotation of the connection gear 520 may be restricted when the input gear 510 is rotated.

In a case in which the input gear 510 is rotated while the rotation of the connection gear 520 is restricted, the first cam portion 514 of the input gear 510 may be rotated while contacting the second cam portion 524 of the connection gear 520. At this time, since the upper end portion 516 of the first cam portion 514 moves toward the lower end portion 525 of the second cam portion 524, the connection gear 520 may move toward the output gear 570 in a state in which the rotation thereof is restricted. That is, the connection gear 520 may move upward.

In the state in which the rotation of the connection gear 520 is restricted, the connection gear 520 may move to a power transmission position or a second position (refer to FIG. 44A).

In a state in which the connection gear 520 is located at the power transmission position, all of the plurality of ball bearings 532 are located in the second slots 553 (refer to FIG. 45).

When the plurality of ball bearings 532 are located in the second slots 553, the connection gear 520 becomes in a rotatable state.

At the power transmission position of the connection gear 520, the first cam portion 514 may maintain a state of being in contact with the second cam portion 524. Accordingly, the connection gear 520 may be rotated when the input gear 510 is rotated.

At the power transmission position of the connection gear 520, a height of at least a portion of the first transmission protrusion 527 may be the same as a height of the second transmission protrusion 573.

Accordingly, when the connection gear 520 is rotated, the first transmission protrusion 527 may be in contact with the second transmission protrusion 573. In a state in which the first transmission protrusion 527 is in contact with (or connected to) the second transmission protrusion 573, the output gear 570 may also be rotated when the connection gear 520 is rotated. That is, at the power transmission position of the connection gear 520, a rotational force of the input gear 510 may be transmitted to the output gear 570 by the connection gear 520.

Meanwhile, when the operation of the driver 110 is stopped, the connection gear 520 may move to the initial position by the elastic force of the elastic member 560. That is, the connection gear 520 may be moved downward by the elastic force of the elastic member 560. Accordingly, the connection between the connection gear 520 and the output gear 570 may be released.

Meanwhile, although the clutch gear assembly described above has been explained as being applied to a refrigerator as an example, there is no limitation to the product to which the clutch gear assembly is applied, and it should be noted that it can be applied to various home appliances other than refrigerators. Furthermore, the clutch gear assembly may also be applied to furniture or the like, in addition to home appliances.

In addition, although the clutch gear assembly has been described as being applied to a door opening and closing device as an example, it may be variously applied to any device requiring transmission and release of power.

What is claimed is:

1. A refrigerator comprising:
a cabinet having a storage space;
a door that opens and closes the storage space; and
a door opening and closing device to open and close the door,
wherein the door opening and closing device includes:
a driver that generates power,
a power transmission portion that transmits the power of the driver, and
an operating portion that receives the power of the driver and operates to open the door and including a link connected to the door,
wherein the power transmission portion includes a clutch gear assembly,
wherein the clutch gear assembly is configured to transmit power to the operating portion or block power transmission, and
wherein the clutch gear assembly includes:
a shaft,
an input gear connected to the driver and through which the shaft passes,
an output gear spaced apart from the input gear, and
a connection gear that moves in an axial direction of the shaft to connect the input gear to the output gear when the driver is operated, and moves in the axial direction of the shaft to disconnect the input gear and the output gear when the driver is stopped.

2. The refrigerator of claim 1,
wherein when the driver is stopped, the connection gear is positioned at an initial position,
wherein, when the driver is operated, the connection gear moves from the initial position to a power transmission position in the axial direction of the shaft, and
wherein, at the power transmission position of the connection gear, the output gear is rotated together with the input gear and the connection gear.

3. The refrigerator of claim 2,
wherein at the power transmission position of the connection gear, the output gear and the connection gear are rotated in the same direction as the input gear.

4. The refrigerator of claim 2,
wherein the clutch gear assembly further includes an elastic member for returning the connection gear to the initial position when the driver is stopped during an operation of the driver.

5. The refrigerator of claim 2,
wherein the input gear includes a first cam portion,
wherein the connection gear includes a second cam portion in contact with the first cam portion,
wherein each of the first cam portion and the second cam portion has a height that is variable in the axial direction or a circumferential direction, and
wherein, when the driver is operated, the connection gear moves toward the output gear in the axial direction of the shaft by a rotation of the input gear.

6. The refrigerator of claim 5,
wherein each of the first cam portion and the second cam portion includes a contact surface that contacts each other in the axial direction of the shaft.

7. The refrigerator of claim 5,
wherein each of the first cam portion and the second cam portion includes a first end and a second end, and
wherein the second end is positioned closer to the output gear in the axial direction of the shaft than the first end.

8. The refrigerator of claim 2,
wherein the connection gear includes a body through which the shaft passes, and
wherein a plurality of first transmission protrusions protruding from the body toward the output gear,
wherein the output gear includes a plurality of second transmission protrusions capable of interacting with the plurality of first transmission protrusions, and
wherein at the initial position of the connection gear, the plurality of first transmission protrusions are spaced apart from the plurality of second transmission protrusions in the axial direction of the shaft.

9. The refrigerator of claim 8,
wherein when the driver operates and the connection gear moves from the initial position to the power transmission position, at least one of the plurality of first transmission protrusions is in contact with at least one of the plurality of second transmission protrusions, so that the connection gear and the output gear are rotated together.

10. The refrigerator of claim 2,
wherein the connection gear includes an opening through which the shaft passes,
wherein a plurality of first protrusions protruding from a surface forming the opening and spaced apart from each other in a circumferential direction, and
wherein the shaft includes:
a first portion,
a second portion having a diameter greater than a diameter of the first portion, and
a second protrusion protruding from the second portion and positioned between two adjacent first protrusions at the initial position of the connection gear.

11. The refrigerator of claim 10,
wherein in a state in which the second protrusion is positioned between the two adjacent first protrusions and the second protrusion is in contact with one or more first protrusions, when the input gear rotates, the connection gear moves in the axial direction of the shaft in a state in which a rotation of the connection gear is restricted, and
wherein, when the second protrusion moves out from between the two adjacent first protrusions, the connection gear becomes in a rotatable state.

12. The refrigerator of claim 2,
wherein the connection gear includes a cam portion having a protrusion for interacting with the input gear,
wherein the shaft includes a first portion,
a second portion positioned outside the first portion, and
a bearing rotatably connected to the second portion, and
wherein at the initial position of the connection gear, the bearing is in contact with the protrusion.

13. The refrigerator of claim 12,
wherein the shaft extends in a first direction, and a rotational center line of the bearing extends in a second direction crossing the first direction,
wherein when the input gear rotates in a state in which the bearing is in contact with the protrusion, the connection gear moves in the axial direction of the shaft in a state in which a rotation of the connection gear is restricted, and
wherein when the bearing and the protrusion are spaced apart from each other, the connection gear becomes in a rotatable state.

14. The refrigerator of claim 2,
wherein the clutch gear assembly further includes a bearing member connected to the connection gear and including a ball bearing,
wherein the shaft includes a first slot in which the ball bearing is received at the initial position of the connection gear, and
wherein a second slot extending in a direction crossing an extension direction of the first slot and in which the ball bearing is received at the power transmission position of the connection gear.

15. The refrigerator of claim 14,
wherein the first slot extends in the axial direction of the shaft, and the second slot extends in a circumferential direction of the shaft,
wherein when the input gear rotates in a state in which the ball bearing is positioned in the first slot, the ball bearing moves along the first slot in a state in which a rotation of the connection gear is restricted, and
wherein when the ball bearing is positioned in the second slot, the connection gear becomes in a rotatable state.

16. The refrigerator of claim 1,
wherein the operating portion includes:
a first operating portion that operates by receiving power from the driver, and
a second operating portion that operates by receiving power from the driver from the output gear and including the link, and
wherein when the driver operates to automatically open the door, the first operating portion starts to operate, and the second operating portion starts to operate after the first operating portion starts to operate.

17. A door opening and closing device for opening and closing a door comprising:
a driver that generates power;
a power transmission portion that transmits the power of the driver; and
an operating portion that receives the power of the driver and operates to open the door,
wherein the operating portion includes:
a first operating portion that operates by receiving the power from the driver, and
a second operating portion that operates by receiving the power from the driver and has a link,
wherein the power transmission portion includes a clutch gear assembly,
wherein the clutch gear assembly transmits power to the second operating portion or block power transmission, and
wherein the clutch gear assembly includes:
an input gear connected to the driver,
an output gear spaced apart from the input gear, and
a connection gear that receives rotational force of the input gear when the driver is operated, moves toward the output gear, connects the input gear to the output gear, and disconnects the input gear and the output gear when the driver is stopped.

18. The door opening and closing device of claim 17,
wherein the clutch gear assembly further includes a shaft passing through the input gear, the connection gear, and the output gear, and
wherein the connection gear moves along an axial direction of the shaft when the input gear rotates.

19. The door opening and closing device of claim 18,
wherein when the driver is stopped, the connection gear is positioned at an initial position, and when the driver is operated, the connection gear moves from the initial position to a power transmission position in an axial direction of the shaft,
wherein during an operation of the driver, the connection gear moves along the axial direction of the shaft in a state in which a rotation of the connection gear is restricted, and
wherein when the connection gear moves to the power transmission position, the connection gear becomes in a rotatable state.

20. The door opening and closing device of claim 19,
wherein the clutch gear assembly further includes an elastic member for causing the connection gear to move from the power transmission position to the initial position when the driver is stopped.
